(19) United States
(12) Patent Application Publication
(10) Pub. No.: US 2015/0177567 A1
(43) Pub. Date: Jun. 25, 2015

(54) LIQUID CRYSTAL ALIGNMENT AGENT, LIQUID CRYSTAL ALIGNMENT FILM AND LIQUID CRYSTAL DISPLAY ELEMENT HAVING THEREOF

(71) Applicant: Chi Mei Corporation, Tainan City (TW)

(72) Inventors: Shin-Rong Chiou, KAOHSIUNG CITY (TW); Wan-Ting Huang, KAOHSIUNG CITY (TW)

(21) Appl. No.: 14/578,531

(22) Filed: Dec. 22, 2014

(30) Foreign Application Priority Data
Dec. 23, 2013 (TW) 102147785

(51) Int. Cl. G02F 1/1337; C08J 5/18; C09K 19/56; C08L 79/08

(52) U.S. Cl. CPC G02F 1/133723; C08L 79/08; C08J 5/18; C09K 19/56; C08J 2379/08

(57) ABSTRACT

The present invention relates to a liquid crystal alignment agent, a liquid crystal alignment film made by the liquid crystal alignment agent and a liquid crystal display element having the liquid crystal alignment film. The liquid crystal alignment agent includes a polymer composition (A), a photopolymerizable compound (B) and a solvent (C). The polymer composition (A) is synthesized by a mixture that includes a tetracarboxylic dianhydride component (a) and a diamine component (b). The aforementioned liquid crystal alignment agent has a lower ion density.

### RELATED APPLICATIONS

This application claims priority to Taiwan Application Serial Number 102147785, filed on Dec. 23, 2013, which is herein incorporated by reference.

### BACKGROUND

1. Field of Invention

The present invention relates to a vertical alignment liquid crystal alignment agent, a liquid crystal alignment film and a liquid crystal display element. More particularly, the present invention relates to a liquid crystal alignment agent having low ion density, a liquid crystal alignment film formed by the liquid crystal alignment agent, and a liquid crystal display element comprises the liquid crystal alignment film.

2. Description of Related Art

Due to an increasing demand for liquid crystal display elements with a wide viewing angle characteristic, and thus the requirement for good electrical or displaying qualities in terms of liquid crystal alignment property has become stricter. Among them, a vertical alignment liquid crystal display element is the most widely investigated. In order to have better properties of the above, liquid crystal alignment film becomes one of the most important investigated subject to improve the properties of the vertical alignment liquid crystal display elements.

The liquid crystal alignment film of vertical alignment liquid crystal display elements is mainly used to provide the liquid crystal molecules with regular arrangement and having a large inclination angle without applying electrical field. The liquid crystal alignment film is produced by coating a polymer material of the liquid crystal alignment agent on a surface of a substrate, and then a baking treatment and an aligning treatment are sequentially performed to the aforementioned substrate that has been coated the liquid crystal alignment agent.

In general, the aforementioned polymer material containing a liquid crystal pretilt composition can obtain a good liquid crystal alignment property. However, the liquid crystal pretilt composition decrease the solubility of polymer, so that the polymer easily aggregate, thereby producing printing mura when the liquid crystal alignment agent is coated on the substrate. Besides, there is a problem of low printability that is caused by polymer precipitation during the long-term printing.

Japanese Laid-Open Publication No. 2013-101303 discloses a liquid crystal alignment agent with better printability in which comprises diamine compound containing more than one carboxyl group to be polymerized with tetracarboxylic dianhydride compound to obtain polyimide with 1,3-Dimethyl-2-imidazolidinone, N-ethyl-2-pyrrolidone or such as the compound of Formula (III) solvents. However, the liquid crystal alignment agent still has the problem of exceeding ion density, especially at low voltages it can not display the correct color scale:

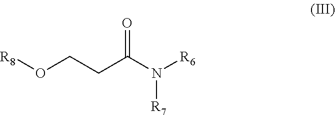

In the Formula (III), R₆ and R₇ respectively represent a hydrogen atom, a hydrocarbon group of 1 to 6 carbons or the hydrocarbon group contains oxygen group (—O—) between carbon-carbon bonds, R₆ and R₇ can form a cyclic structure; and R₈ represents an alkyl group of 1 to 6 carbons.

According to the aforementioned aspects, in order to meet the requirement of present liquid crystal display element industry, how to provide a liquid crystal alignment agent with low ion density becomes one of the goals of present technical field.

### SUMMARY

Therefore, an aspect of the present invention provides a liquid crystal alignment agent, which comprises a polymer composition (A), a photopolymerizable compound (B) and a solvent (C), and the liquid crystal alignment agent can improve the defect of exceeding ion density.

Another aspect of the invention provides a liquid crystal alignment film formed by the aforementioned liquid crystal alignment agent.

A further aspect of the invention provides a liquid crystal display element having the aforementioned liquid crystal alignment film.

The liquid crystal alignment agent comprises a polymer composition (A), a photopolymerizable compound (B) and a solvent (C) all of which are described in details as follows.

### Polymer Composition (A)

The polymer composition (A) is selected from polyamic acid, polyimide, polyimide series block-copolymer and a combination thereof. The polyimide series block-copolymer is selected from polyamic acid block-copolymer, polyimide series block-copolymer, polyamic acid-polyimide series block-copolymer or in a combination thereof.

The polyamic acid, polyimide and polyimide series block-copolymer of the polymer composition (A) all synthesized by reacting a mixture that includes a tetracarboxylic dianhydride component (a) and a diamine component (b). The tetracarboxylic dianhydride component (a), the diamine component (b) and a method of producing the polymer composition (A) all of which are described in details as follows.

### Tetracarboxylic Dianhydride Component (a)

The tetracarboxylic dianhydride component (a) can be selected from the group consisting of an aliphatic tetracarboxylic dianhydride compound, an alicyclic tetracarboxylic dianhydride compound, an aromatic tetracarboxylic dianhydride compound, and a tetracarboxylic dianhydride compound (a) having a structure of Formulas (IV-1) to (IV-6).

For example, the aliphatic tetracarboxylic dianhydride compound can include but is not limited to ethanetetracarboxylic dianhydride, butanetetracarboxylic dianhydride and the like.

For example, the alicyclic tetracarboxylic dianhydride compound can include but is not limited to 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dicholoro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyl tetracarboxylic dianhydride, cis-3,7-dibutylcycleheptyl-1,5-diene-1,2,5,6-tetracarboxylic dianhydride, 2,3,5-tricarboxycyclopentyl acetic dianhydride or bicyclo[2.2.2]oct-7-ene-2,3,5,6-tetracarboxylic acid dianhydride the like as the tetracarboxylic dianhydride components.

Examples of the aromatic tetracarboxylic dianhydride compound can include but is not limited to 3,4-dicarboxy-1,2,3,4-tetrahydronaphthalene-1-succinic dianhydride, pyromellitic dianhydride, 2,2′,3,3′-benzophenone tetracarboxylic dianhydride, 3,3′,4,4′-benzophenonetetracarboxylic dianhydride, 3,3′,4,4′-diphenylsulfonetetracarboxylic dianhydride, 1,4,5,8-naphthalene tetracarboxylic dianhydride, 2,3,6,7-naphthalenetetracarboxylic dianhydride, 3,3′-4,4′-diphenylethanetetracarboxylic dianhydride, 3,3′,4,4′-dimethyldiphenyl-silanetetracarboxylic dianhydride, 3,3′,4,4′-tetraphenylsilanetetracarboxylic dianhydride, 1,2,3,4-furantetracarboxylic dianhydride, 2,3,3′,4′-diphenyl ether tetracarboxylic dianhydride, 3,3′,4,4′-diphenyl ether tetracarboxylic dianhydride, 4,4′-bis(3,4-dicarboxyphenoxy)diphenylsulfide dianhydride, 2,3,3′,4′-diphenylsulfide dianhydride, 3,3′,4,4′-diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoro-isopropylidenediphthalic dianhydride, 2,2′,3,3′-diphenyl tetracarboxylic dianhydride, 2,3,3′,4′-diphenyl tetracarboxylic dianhydride, 3,3′,4,4′-diphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofuran tetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-di one, 1,3,3a,4,5,9b-hexahydro-7-methyl-5-(tetrahydro-2,5-dioxo-3-furanyl)-naphtho[1,2-c]uran-1,3,-dione, 1,3,3a,4,5,9b-hexahydro-7-ethyl-5-(tetrahydro-2,5-dioxo-3-furanyl)-naphtho[1,2-c]-furan-1,3,-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, 5-(2,5-dioxotetrahydrofuranyl)-3-methyl-3-cyclohexene-1,2-dicarboxylic dianhydride or the like.

The tetracarboxylic dianhydride component (a) having a structure of Formulas (IV-1) to (IV-6) are shown as follows:

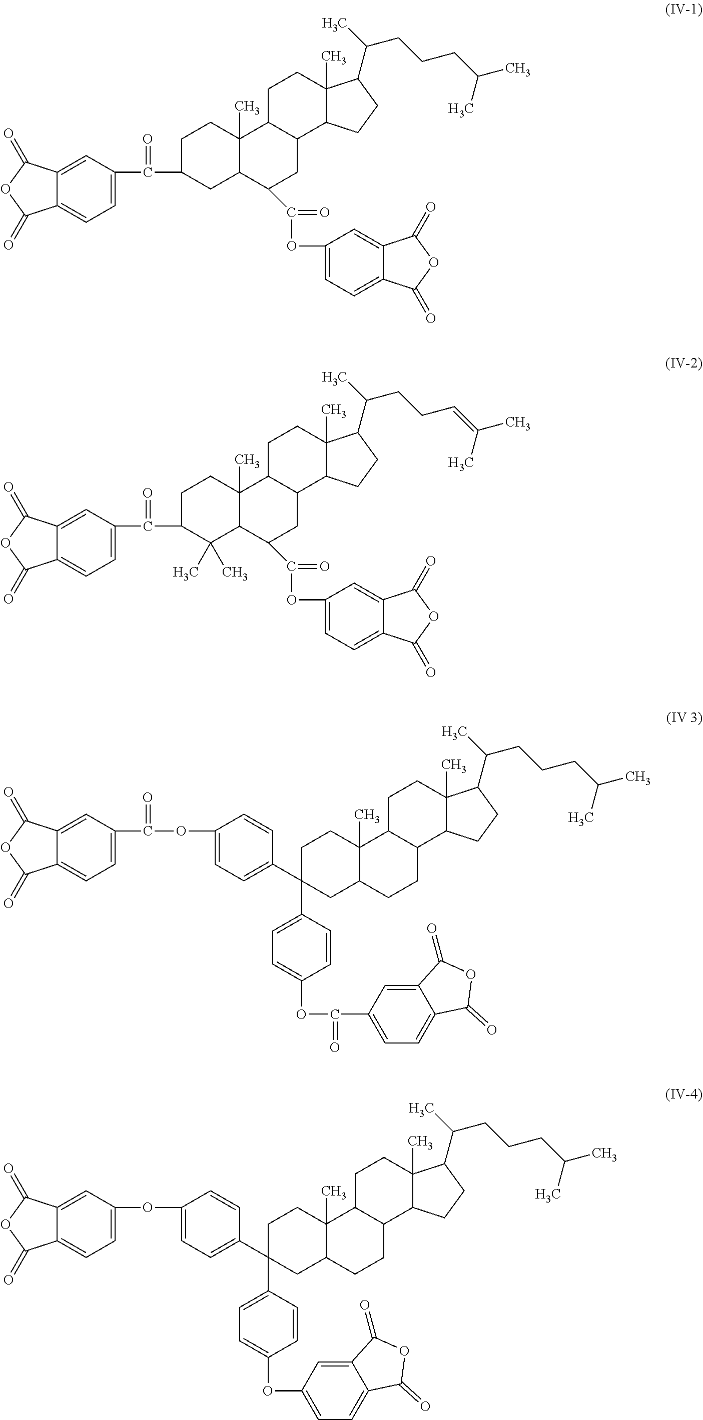

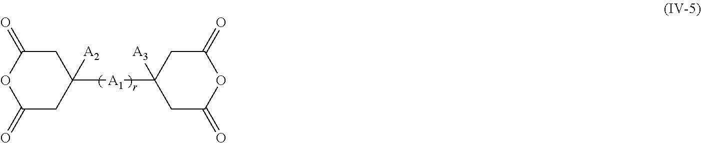

In the Formula (IV-5), A₁ is a divalent group containing an aromatic ring; A₂ and A₃ can be the same or different, and A₂ and A₃ respectively are a hydrogen atom or an alkyl group; r is an integer of 1 to 2. Preferably, the tetracarboxylic dianhydride component (a) of Formula (IV-5) can be selected from the group consisting of the following compounds having a structure of Formulas (IV-5-1) to (IV-5-3):

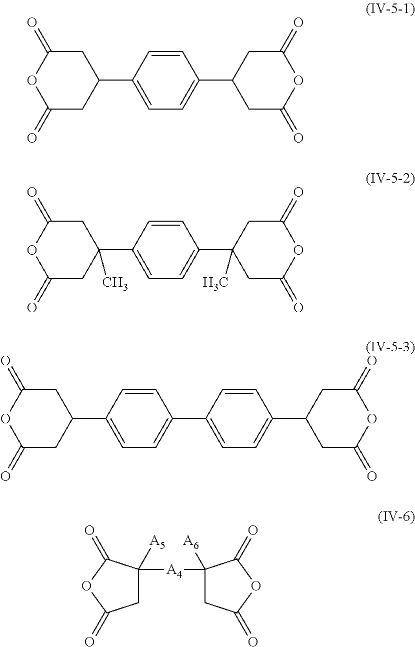

In the Formula (IV-6), A₄ is a divalent group containing aromatic ring(s); A₅ and A₆ can be the same or different, and A₅ and A₆ respectively are a hydrogen atom or an alkyl group. Preferably, the tetracarboxylic dianhydride component (a) of Formula (IV-6) can be further selected from the group having a structure of Formula (II-6-1) is shown as follow:

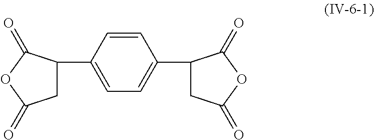 [SMILES: O=C1CC(c2ccc(C3CC(=O)OC3=O)cc2)C(=O)O1]

Preferably, the tetracarboxylic dianhydride component (a) can include but is not limited to 1,2,3,4-cyclobutane tetracarboxylic dianhydride, 1,2,3,4-cyclopentane tetracarboxylic dianhydride, 2,3,5-tricarboxycyclopentyl acetic dianhydride, 1,2,4,5-cyclohexane tetracarboxylic dianhydride, 3,4-dicarboxy-1,2,3,4-tetrahydronaphthalene-1-succinic dianhydride, pyromellitic dianhydride, 3,3′,4,4′-benzophenonetetracarboxylic dianhydride and 3,3′,4,4′-diphenylsulfonetetracarboxylic dianhydride. The aforementioned tetracarboxylic dianhydride component (a) can be used alone or in a combination of two or more.

### Diamine Component (b)

The diamine component (b) includes a diamine compound containing carboxyl group (b-1) and a diamine compound (b-2).

Diamine Compound Containing Carboxyl Group (b-1)

The present invention includes diamine compound containing carboxyl group (b-1) having a structure of Formula (II) is shown as follow:

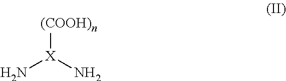

In the Formula (II), X is aromatic organic group of 6 to 30 carbons, and n is an integer of 1 to 4.

There is no particular limitation with a structure of the diamine compound containing carboxyl group (b-1) besides the structure of which contains carboxylic acid group. The diamine compound containing carboxyl group (b-1) can include but is not limited to aliphatic diamine, alicyclic diamine, aromatic diamine or diamino organo-siloxane. The diamine compound containing carboxyl group (b-1) preferably is alicyclic diamine or aromatic diamine, and more preferably is aromatic diamines.

Preferably, the tetracarboxylic dianhydride compound (b-1) has 1 to 4 carboxyl groups, and more preferably has 1 or 2 carboxyl group.

The diamine compound containing carboxyl group (b-1) of Formula (II) can include but is not limited to the following diamine compounds having a structure of Formulas (II-1) to (II-5) are shown as follows:

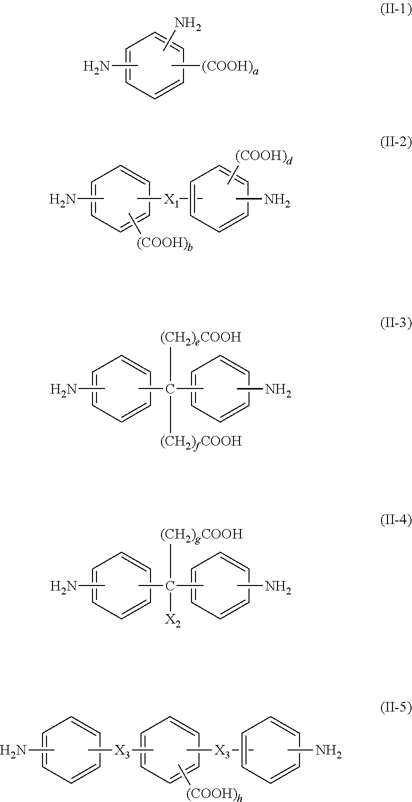

In the aforementioned Formulas (II-1) to (II-5), X₁ and X₃ respectively can be single bond, —CH₂—, —C₂H₄—, —C(CH₃)₂—, —CF₂—, —C(CF₃)₂—, —O—, —CO—, —NH—, —N(CH₃)—, —CONH—, —NHCO—, —CH₂O—, —OCH₂—, —COO—, —OCO—, —CON(CH₃)— or —N(CH₃)CO—. X₂ is a straight-chain alkane of 1 to 5 carbons or branched-chain alkane of 1 to 5 carbons. The a and h respectively are an integer of 1 to 4. The b and d respectively are an integer of 0 to 4, and (b+d) is an integer of 1 to 4. The e, f and g respectively are an integer of 1 to 5.

Preferably, in the Formula (II-1), a is 1 or 2; in the Formula (II-2), X₁ is single bond, —CH₂—, —C₂H₄—, —C(CH₃)₂—, —O—, —CO—, —NH—, —N(CH₃)—, —CONH—, —NHCO—, —COO— or —OCO—, and at b and d simultaneously are 1; in the Formula (II-5), X₃ represents single bond, —CH₂—, —O—, —CO—, —NH—, —CONH—, —NHCO—, —CH₂O—, —OCH₂—, —COO— or —OCO—, and h represents 1 or 2.

Examples of the diamine compound containing carboxyl group having a structure of Formulas (II-6) to (II-16) are shown as follows:

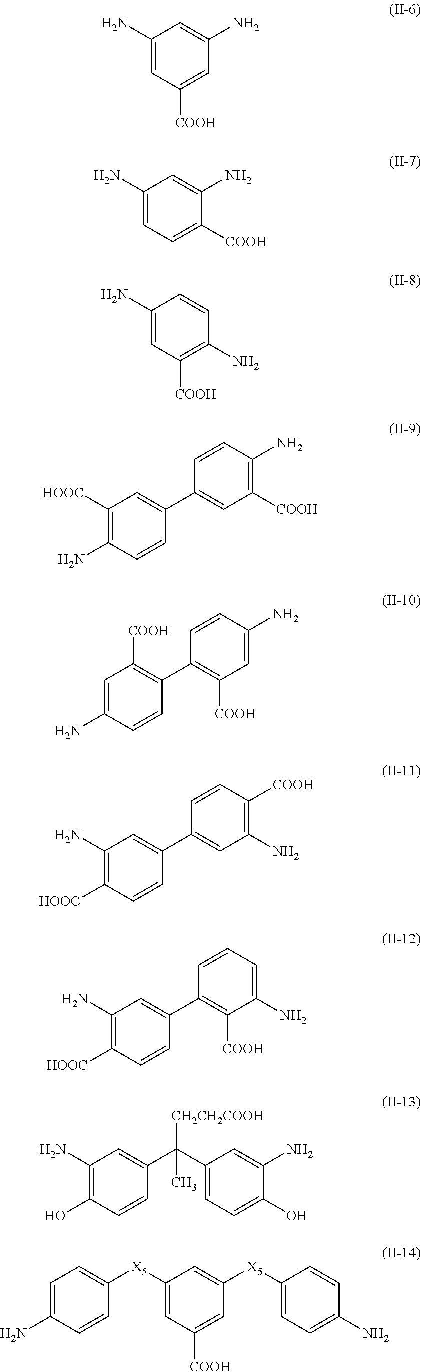

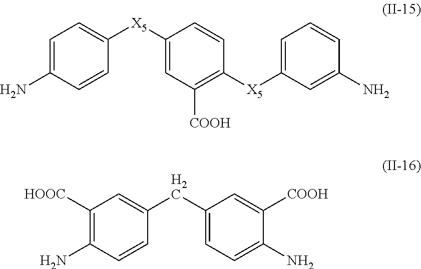

The aforementioned Formulas (II-14) and (II-15), X₅ can represent single bond, —CH₂—, —O—, —CO—, —NH—, —CONH—, —NHCO—, —CH₂O—, —OCH₂—, —COO— or —OCO—.

The aforementioned diamine compounds containing carboxyl group (b-1) can be used alone or in a combination of two or more.

Based on the total amount of the diamine component (b) as 100 moles, an amount of the diamine compound containing carboxyl group (b-1) is normally 20 moles to 60 moles, preferably is 25 moles to 55 moles, and more preferably is 30 moles to 50 moles.

When the present invention diamine component (b) of polymer composition (A) does not include diamine compound containing carboxyl group (b-1), the prepared liquid crystal alignment agent has the defect of exceeding ion density.

Other Diamine Compounds (b-2)

The other diamine compounds (b-2) can include but is not limited to 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4′-diamino-dicyclohexyl methane, 4,4′-diamino-3,3′-dimethyl-dicyclohexyl amine, 1,3-diaminocyclohexane, 1,4-diaminocyclohexane, isophoronediamine, tetrahydrodicyclopentadiene diamine, tricyclo[6.2.1.0^{2,7}]-undecene dimethyl-diamine, 4,4′-methylenebis(cyclohexylamine), 4,4′-diaminodiphenyl methane, 4,4′-diaminodiphenyl ethane, 4,4′-diaminodiphenyl sulfone, 4,4′-diaminobenzanilide, 4,4′-diaminodiphenyl ether, 3,4′-diaminodiphenyl ether, 1,5-diaminonaphthalene, 5-amino-1-(4′-aminophenyl)-1,3,3-trimethyl hydroindene, 6-amino-1-(4′-aminophenyl)-1,3,3-trimethyl hydroinden, hexahydro-4,7-methylene hydroindenyl dimethylene diamine, 3,3′-diamino benzophenone, 3,4′-diamino benzophenone, 4,4′-diamino benzophenone, 2,2-bis[4-(4-aminophenoxyl)phenyl]propane, 2,2-bis[4-(4-aminophenoxyl)phenyl]hexafluoropropane, 2,2-bis(4-aminophenyl) hexafluoropropane, 2,2-bis[4-(4-aminophenoxyl)phenyl]sulfone, 1,4-bis(4-aminophenoxy)benzene, I,3-bis(4-aminophenoxy)benzene, 1,3-bis(3-aminophenoxy)benzene, 9,9-bis(4-amino-phenyl)-10-hydroanthracene, 9,10-bis(4-aminophenyl) anthracene, 2,7-diaminofluorene, 9,9-bis(4-aminophenyl) fluorene, 4,4′-methylene-bis(2-chloroaniline), 4,4′-(p-phenylene isopropylidene)dianiline, 4,4′-(m-phenylene isopropylidene)dianiline, 2,2′-bis[4-(4-amino-2-(trifluoromethyl)phenoxy)phenyl]hexafluoropropane, 4,4′-bis[(4-amino-2-trifluoromethyl)phenoxy]-octafluorobiphenyl, 5-[4-(4-n-pentylcyclohexyl)cyclohexyl]phenylmethylene-1,3-diaminobenzene, 1,1-bis[4-(4-aminophenoxyl)phenyl]-4-(4-ethylphenyl)cyclohexane or the other diamine compounds (b-2) having a structure of Formulas (V-1) to (V-30):

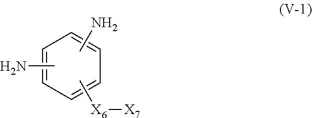

In the Formula (V-1), X₆ represents

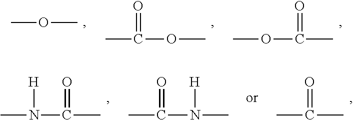

and X₇ represents a steroid-containing group, a trifluoromethyl group, a fluoro atom, an alkyl group of 2 to 30 carbons or a monovalent group that has a nitrogen-containing ring structure derived from pyridine, pyrimidine, triazine, piperidine and piperazine.

The diamine compound of Formula (V-1) is preferably selected from the group consisting of 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene or other diamine compounds (b-2) having a structure of Formulas (V-1-1) to (V-1-6):

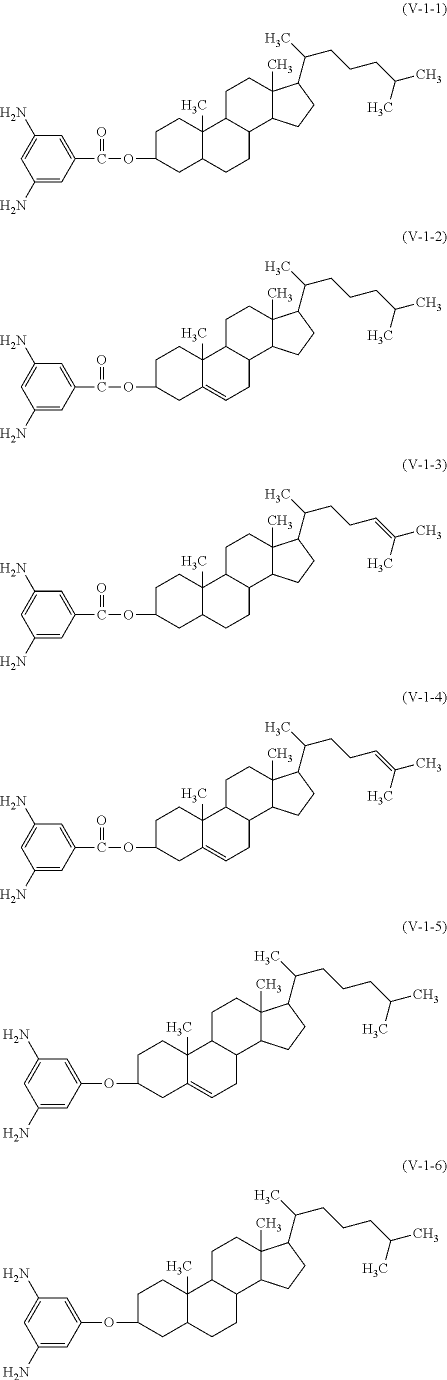

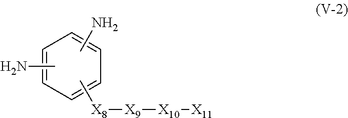

In the Formula (V-2), X₈ represents

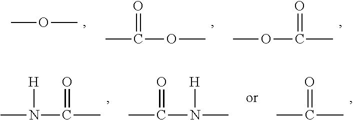

X₉ and X₁₀ represent a divalent group of an aliphatic ring, an aromatic ring or a heterocyclic ring; and the X₁₁ represents an alkyl group of 3 to 18 carbons, an alkoxy group of 3 to 18 carbons, a fluoroalkyl group of 1 to 5 carbons, a fluoroalkoxy group of 1 to 5 carbons, a cyano group or a halogen atom.

Preferably, the diamine compound of Formula (V-2) is shown from the group consisting of diamine compounds having a structure of Formulas (V-2-1) to (V-2-13) are shown as follows:

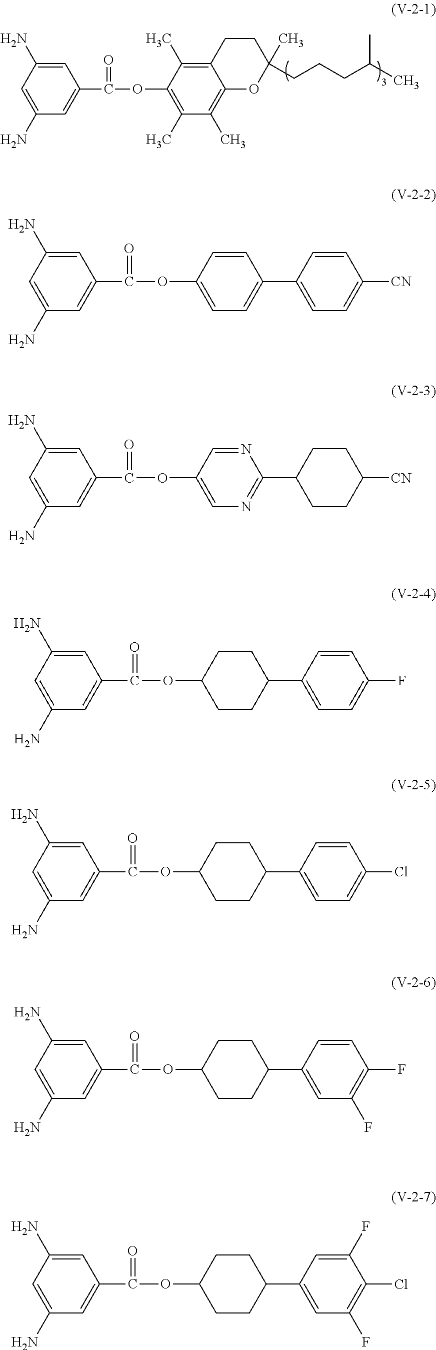

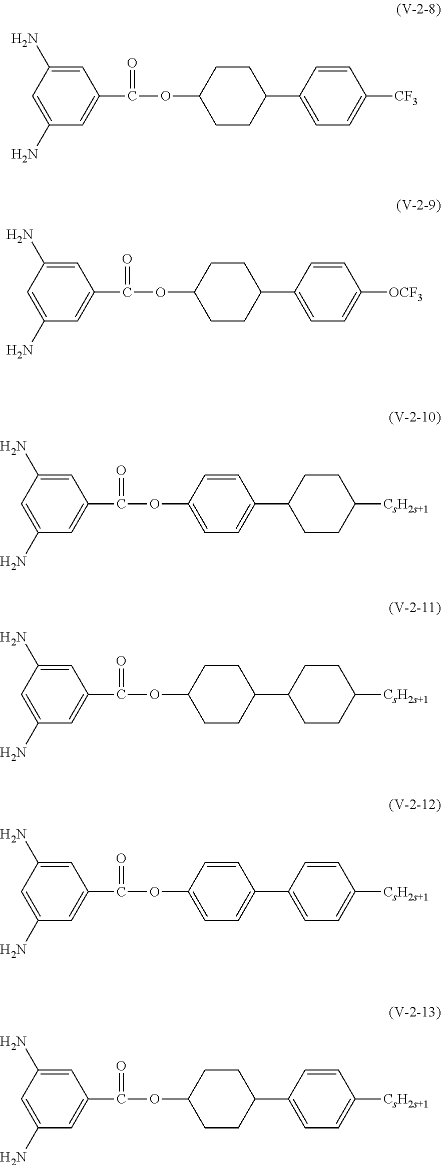

In the Formula (V-2-10) to (V-2-13), s can represent an integer of 3 to 12.

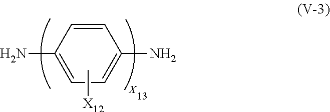

In the Formula (V-3), X₁₂ represents a hydrogen atom, an acetyl group of 1 to 5 carbons, an alkyl group of 1 to 5 carbons, an alkoxy group of 1 to 5 carbons or a halogen atom and X₁₂ of each repeating unit can be the same or different. X₁₃ is an integer of 1 to 3.

The diamine compound of the Formula (V-3) is preferably selected from the group consisting of the following ones: (1) when the X₁₃ is 1: p-diaminobenzene, m-diaminobenzene, o-diaminobenzene, 2,5-diaminotoluene or the like; (2) when the X₁₃ is 2: 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl 2,2′-dichloro-4,4′-diamino-5,5′-dimethoxybiphenyl, 4,4′-diamino-2,2′-bis(trifluoromethyl)biphenyl or the like; (3) when the X₁₃ is 3: 1,4-bis(4′-aminophenyl)benzene. More preferably, the diamine compound is selected from p-diaminobenzene, 2,5-diaminotoluene, 4,4′-diaminobiphenyl, 3,3′-dimethoxy-4,4′-diaminobiphenyl or 1,4-bis(4′-aminophenyl)benzene.

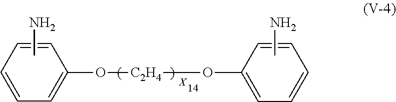

In the Formula (V-4), X₁₄ represents an integer of 2 to 12.

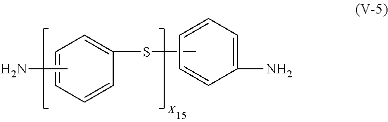

In the Formula (V-5), X₁₅ represents an integer of 1 to 5. The compound of Formula (V-5) is preferably 4,4′-diaminodiphenyl thioether.

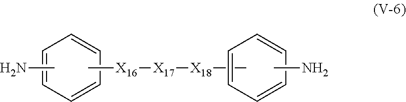

In the Formula (V-6), X₁₆ and X₁₈ can be the same or different, and X₁₆ and X₁₈ respectively are a divalent organic group. X₁₇ represents divalent group that has a nitrogen-containing ring structure derived from pyridine, pyrimidine, triazine, piperidine and piperazine.

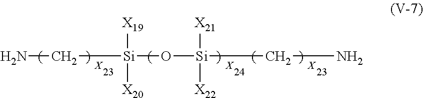

In the Formula (V-7), X₁₉, X₂₀, X₂₁ and X₂₂ can represent the same or different, and can represent a hydrocarbon group of 1 to 12 carbons. X₂₃ represents an integer of 1 to 3, and X₂₄ represents an integer of 1 to 20.

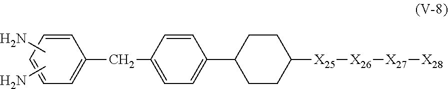

In the Formula (V-8), X₂₅ represents —O— or cyclohexalene, the X₂₆ represents —OH₂—, the X₂₇ represents phenylene or cyclohexalene, and the X₂₈ represents hydrogen atom or heptyl group.

The diamine compound of Formula (V-8) is preferably selected from the group consisting of diamine compounds having a structure of Formulas (V-8-1) to (V-8-2) are shown as follows:

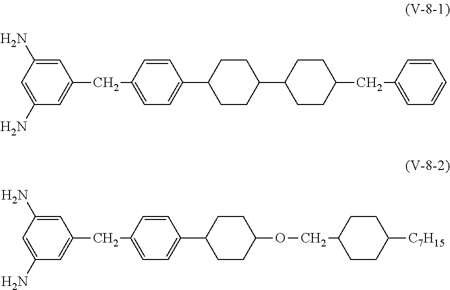

The diamine compound having a structure of Formula (V-9) to (V-30) are shown as follows:

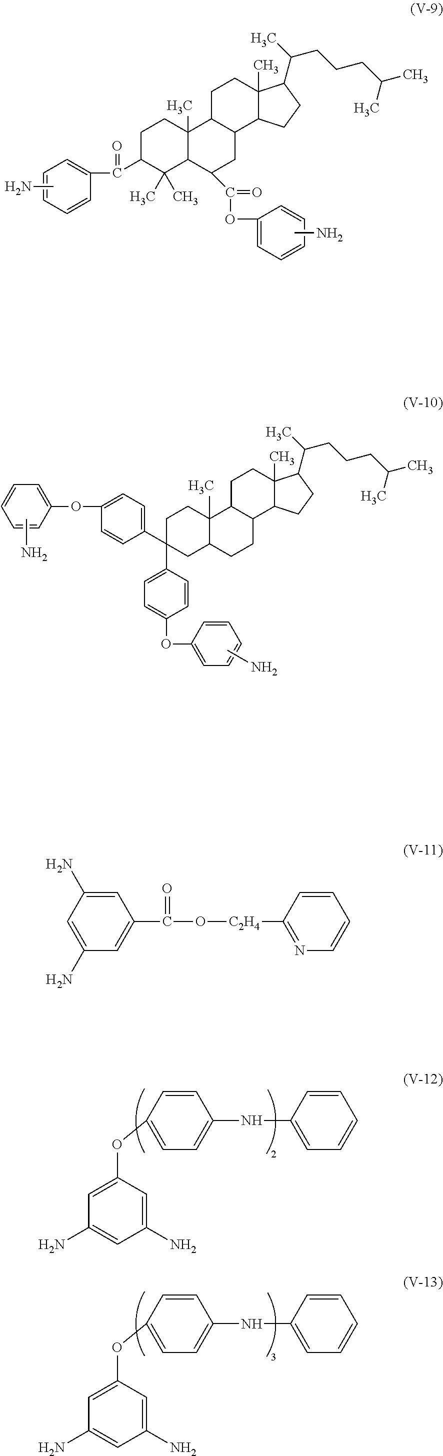

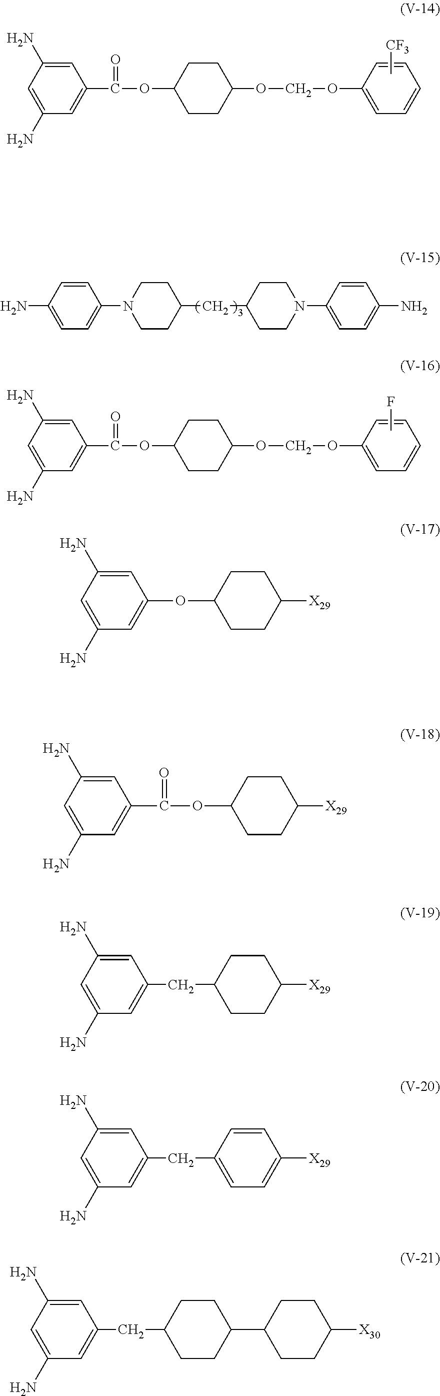

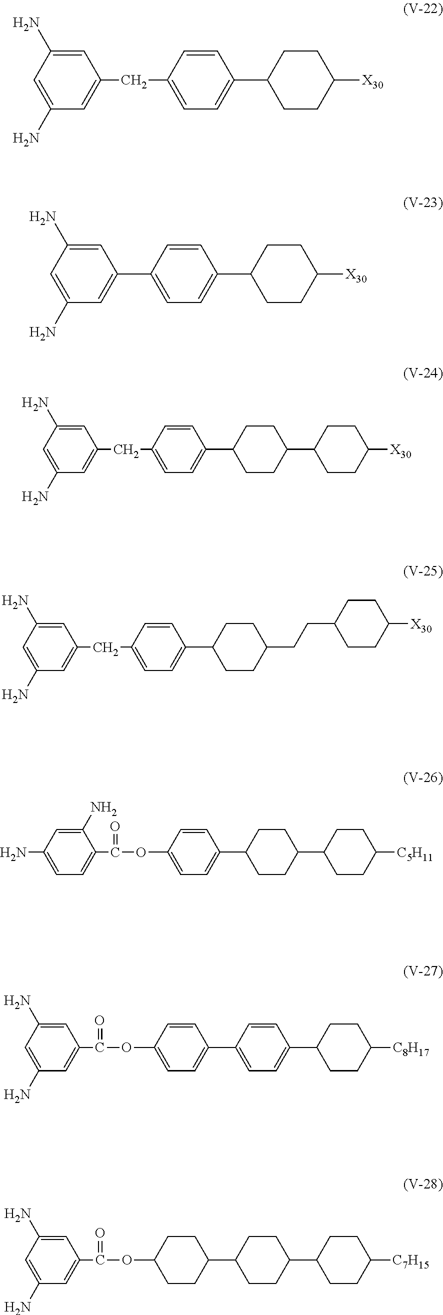

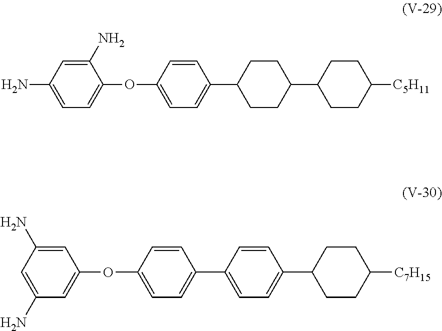

In the Formulas (V-17) to (V-25), X₂₉ is an alkyl group of 1 to 10 carbons, or preferably an alkoxy group of 1 to 10 carbons, and X₃₀ is preferably a hydrogen atom, an alkyl group of 1 to 10 carbons or an alkoxy group of 1 to 10 carbons. The diamine compound (b-2) can preferably include but is not limited to 1,2-diaminoethane, 4,4′-diaminodicyclohexylmethane, 4,4′-diaminodiphenyl methane, 4,4′-diaminodiphenyl ether, 5-[4-(4-n-pentylcyclohexyl)cyclohexyl]phenylmethylene-1,3-diamino benzene, 1,1-bis[4-(4-aminophenoxyl)phenyl]-4-(4-ethylphenyl)cyclohexane, 2,4-diaminophenyl ethyl formate, p-diaminobenzene, m-diaminobenzene, o-diaminobenzene or the diamine compound having a structure of Formulas (V-1-1), (V-1-2), (V-1-5), (V-2-1), (V-2-11), (V-8-1), (V-26) or (V-29).

The aforementioned diamine compound (b-2) can be used alone or in a combination of two or more.

Based on the total amount of the diamine component (b) as 100 moles, an amount of the aforementioned diamine component (b-2) is generally 40 moles to 80 moles, preferably is 45 moles to 75 moles, and more preferably is 50 moles to 70 moles.

### Method of Producing Polymer Composition (A)

Method of Producing Polyamic Acid

A mixture including the tetracarboxylic dianhydride component (a) and the diamine component (b) is dissolved in a solvent and then subjected to a polycondensation reaction at 0° C. to 100° C. After 1 hour to 24 hours, the aforementioned reacting solution is subjected to a reduced pressure distillation by an evaporator, so as to obtain the polyamic acid. Alternatively, the reacting solution was poured into a great quantity poor solvent to obtain a precipitate, and then the precipitate is dried under a reduced pressure, so as to obtain the polyamic acid.

Based on the total amount of the diamine component (b) as 100 moles, an amount of the tetracarboxylic dianhydride component (a) is preferably 20 moles to 200 moles, and more preferably is 30 moles to 120 moles.

The aforementioned solvent used in the polycondensation reaction can be the same as or different from the solvent in the liquid crystal alignment agent. The solvent used in the polycondensation reaction is used to dissolve the reactant and the product without any specific limitation. Preferably, the solvent can include but is not limited to (1) aprotic polar solvents: N-methyl-2-pyrrolidinone, N,N-dimethylacetamide, N,N-dimethylformamide, dimethylsulfoxide, γ-butyrolactone, tetramethylurea, hexamethylphosphoric acid triamide or the like; and (2) phenolic solvents: m-cresol, xylenol, phenol, halogen phenols or the like. Based on the total amount of the mixture as 100 parts by weight, an amount of the solvent of the polycondensation reaction is 200 parts by weight to 2,000 parts by weight, and more preferably is 300 parts by weight to 1,800 parts by weight.

Particularly, in the polycondensation reaction the solvent can be used in combination with a poor solvent in an appropriate amount such that the polyamic acid will not be precipitated out. The poor solvent can be used alone or in combination with two or more. The poor solvent can include but is not limited to: (1) alcohols: methanol, ethanol, isopropanol, cyclohexanol, ethylene glycol, propylene glycol, 1,4-butanediol, triethylene glycol or the like; (2) ketones: acetone, methyl ethyl ketone, methyl isobutyl ketone, cyclohexanone or the like; (3) esters: methyl acetate, ethyl acetate, butyl acetate, diethyl oxalate, diethylmalonate, ethylene glycol ethyl ether acetate or the like; (4) ethers: diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether or the like; (5) halogen hydrocarbons: dichloromethane, 1,2-dichloroethane, 1,4-dichlorobutane, trichloroethane, chlorobenzene, o-dichlorobenzene or the like; (6) hydrocarbons: tetrahydrofuran, hexane, heptane, octane, benzene, toluene, xylene or in a combination thereof. Based on the total amount of the diamine component (b) as 100 parts by weight, an amount of the poor solvent is 0 part by weight to 60 parts by weight, and more preferably is 0 part by weight to 50 parts by weight.

Method of Producing Polyimide

A mixture including the tetracarboxylic dianhydride component (a) and the diamine component (b) is dissolved in a solvent and then subjected to polycondensation reaction, thereby forming the polyimide. And then, in the presence of a dehydrating agent and an imidization catalyst, the reacting solution is heated and subjected to a dehydration ring-closure reaction, thereby converting the amic acid group of the polyamic acid polycondensation reaction to an imide group (i.e. imidization), so as to obtain polyimide.

The aforementioned solvent used in the dehydration ring-closure reaction can be the same as the solvent in the liquid crystal alignment agent and is not illustrated any more here. Based on the an amount of the polyamic acid as 100 parts by weight, an amount of the solvent used in the dehydration ring-closure reaction preferably is 200 parts by weight to 2,000 parts by weight, and more preferably is 300 parts by weight to 1,800 parts by weight.

In order to obtain a better imidization percentage of polyamic acid, the temperature of dehydration ring-closure reaction preferably is under 40° C. to 200° C., more preferably is 40° C. to 150° C. If the temperature of dehydration ring-closure reaction is lower than 40° C., the reaction of imidization is not complete and lower the imidization percentage of polyamic acid. However, if the temperature of dehydration ring-closure reaction is higher than 200° C., the weight-average molecular weight of the obtained polyimide will be lower.

The range of imidization percentage of polymer composition (A) is generally 30% to 90%, preferably is 35% to 85%, and more preferably is 40% to 80%. When the imidization percentage of polymer composition (A) is 30% to 90%, the prepared liquid crystal alignment agent has a lower ion density.

The dehydrating agent used in the dehydration ring-closure reaction is selected from the group consisting of acid anhydride compound. For example, the acid anhydride compound includes acetic anhydride, propionic anhydride, trifluoroacetic anhydride and the like. Based on the amount of the polyamic acid as 1 mole, an amount of the dehydrating agent is 0.01 moles to 20 moles. Moreover, the catalyst used in the dehydration ring-closure reaction includes: (1) pyridine compounds: pyridine, trimethylpyridine, dimethylpyridine or the like; and (2) tertiary amines: triethylamine or the like. An amount of the catalyst is generally 0.5 moles to 10 moles based on the amount of the dehydrating agent as 1 mole.

### Method of Producing Polyimide Series Block-Copolymer

The polyimide series block-copolymer is selected from the group consisting of polyamic acid block-copolymer, polyimide block-copolymer, polyamic acid-polyimide block-copolymer or in a combination thereof.

Preferably, a starting material is dissolved in a solvent, and a polycondensation reaction is performed to produce polyimide series block-copolymer. The starting material includes at least one aforementioned polyamic polymer and/or at least one aforementioned polyimide, and further includes the tetracarboxylic dianhydride component (a) and the diamine component (b) polycondensation reaction.

In the starting material, the tetracarboxylic dianhydride component (a) and the diamine component (b) are the same as the aforementioned tetracarboxylic dianhydride component (a) and the diamine component (b) used in the method of producing the polyamic acid. The solvent used in the polycondensation reaction is the same as the solvent used in the liquid crystal alignment agent, and is not illustrated any more here.

Based on the an amount of the starting material as 100 parts by weight, an amount of the solvent of the polycondensation reaction is 200 parts by weight to 2,000 parts by weight, and more preferably is 300 parts by weight to 1,800 parts by weight. The operating temperature of the polycondensation reaction is preferably 0° C. to 200° C., and more preferably is 0° C. to 100° C.

Preferably, the precursor can include but is not limited to (1) two kinds of the polyamic acid with different terminal groups and different structures; (2) two kinds of the polyimide with different terminal groups and different structures; (3) polyamic acid and polyimide that have different terminal groups and different structures; (4) the polyamic acid, the tetracarboxylic dianhydride component and the diamine component, among them, the structure of the at least one tetracarboxylic dianhydride component and the diamine component is different from the one used in the formation of polyamic acid; (5) polyamic acid, tetracarboxylic dianhydride component and the diamine component, among them, the structure of the at least one tetracarboxylic dianhydride component and the diamine component is different from the one used in the formation of polyimide; (6) polyamic acid, polyimide, tetracarboxylic dianhydride component and the diamine component, among them, the structure of the at least one tetracarboxylic dianhydride component and the diamine component is different from the one used in the formation of polyamic acid and polyimide; (7) two kinds of polyamic acid, tetracarboxylic dianhydride component and the diamine component that have different structures; (8) two kinds of polyimide, tetracarboxylic dianhydride component and the diamine component that have different structures, (9) two kinds of polyamic acid and a diamine component, and the two polyamic groups have different structures and the terminal groups of the polyamic acid are acetic anhydride groups; (10) two kinds of polyamic acid and a tetracarboxylic dianhydride component, and the two polyamic acid have different structures, and the terminal groups of the polyamic acid are amine groups; (11) two kinds of polyimide and a diamine component, and the two polyimide have different structures and the end groups of the polyimide are acid anhydride groups; (12) two kinds of polyimide and a tetracarboxylic dianhydride component, and the two polyimide have different structures and the terminal groups of the polyimide are amine groups.

Preferably, without departing from the efficiency of the present invention, the polyamic acid, polyimide and polyimide block-copolymer are terminal-modified polymers, which can adjust the molecular weight. The terminal-modified polymer can improve the coating ability of the liquid crystal alignment agent. When the polycondensation reaction of the polyamic acid is performed, a compound having a mono functional group is added to produce the terminal-modified polymer. The monofunctional compound includes but is not limited to (1) monoacyltartaric acids, for example: maleic anhydride, phthalic anhydride, itaconic anhydride, succinic anhydride, n-decyl, n-dodecyl succinic anhydride, n-tetradecyl, n-hexadecyl succinic anhydride, succinic acid anhydride or the like; (2) monoamine compound, for example: Aniline, cyclohexylamine, n-butylamine, n-pentylamine, n-hexylamine, n-heptylamine, n-octylamine, n-nonylamine, n-decylamine, n-undecylamine, n-dodecylamine, n-tridecylamine, n-tetradecylamine, n-pentadecaneamine, n-hexadecylamine, n-heptadecaneamine, n-octadecylamine, n-eicosylamine or the like; (3) monoisocyanate compounds, for example: isocyanate phenyl isocyanate, isocyanate naphthalenyl ester or the like.

### Photopolymerizable Compound (B)

The present invention of photopolymerizable compound (B) having a structure of Formula (I) is shown as follow:

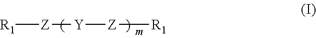

In the Formula (I), R₁ is polymerizable functional group having a structure of Formulas (I-1) to (I-5), a hydrogen atom, a halogen atom, —CN, —CF₃, —CF₂H, —CFH₂, —OCF₃, —OCF₂H, —N═C═O, —N═C═S or an alkyl group of 1 to 20 carbons. Any —CH₂— in the alkyl group can be optionally replaced by —O—, —S—, —SO₂—, —CO—, —COO—, —OCO—, —CH═CH—, —CF═CF— or —C≡C—, and any hydrogen atom in the alkyl group can be optionally replaced by a halogen atom or —CN. Y can represent a divalent group containing a saturated or an unsaturated separated ring, a condensed ring or a spiro ring of 3 to 20 carbons. Any —CH₂— in the ring can be optionally replaced by —O—, any —CH═ in the ring can be optionally replaced by —N═, and any —H in the ring can be optionally replaced by a halogen atom, —CN, —NO₂, —NC, —N═C═O, —N═C═S, a silyl group, a straight-chain of 1 to 10 carbons alkyl group, a branched-chain alkyl group of 1 to 10 carbons, or a haloalkyl group of 1 to 10 carbons. Any —CH₂— in the alkyl group can be optionally replaced by —O—, —CO—, —COO—, —OCO—, —OCOO—, —CH═CH— or —C≡C—. Z can represent an alkylene group of 1 to 20 carbons, —CH₂— in the alkylene group can be optionally replaced by —O—, —S—, —SO₂—, —CO—, —COO—, —OCO—, —OCOO—, —CH═CH—, —CF═CF—, —CH═N—, —N═CH—, —N═N—, —N(O)=N— or —C≡C—, and any —H in the alkylene group can be optionally replaced by a halogen atom, an alkyl group of 1 to 10 carbons or a haloalkyl group of 1 to 10 carbons. The m can represent an integer of 1 to 6. When m represent an integer of 2 to 6, the plural —Y—Z— can be the same or different.

At least one aforementioned R₁ is polymerizable functional group having a structure of Formulas (I-1) to (I-5) are shown as follows:

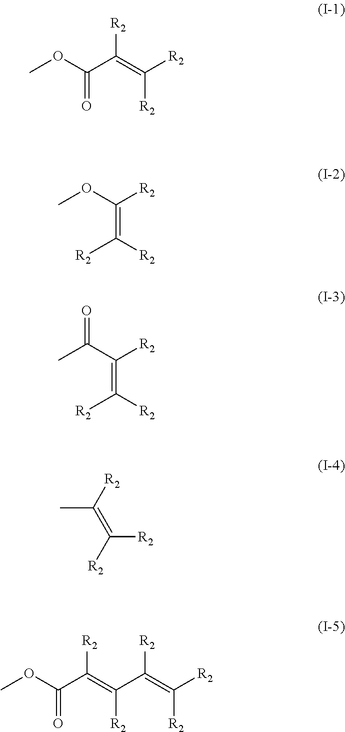

In the Formulas (I-1) to (I-5), R₂ can represent a hydrogen atom, a halogen atom, —CF₃ or an alkyl group of 1 to 5 carbons.

Preferably, in the aforementioned Formula (I), at least one R₁ of the photopolymerizable compound (B) has the structure of Formulas (I-1) to (I-3).

In the aforementioned Formula (I), for example, the cyclic group in Y includes the divalent group such as 1,4-cyclohexylene, 1,4-cyclohexenylene, 1,4-phenylene, naphthalene-2,6-diyl, tetrahydronaphthalene-2,6-diyl, fluorene-2,7-diyl, bicyclo[2.2.2]octane-1,4-diyl, bicyclo[3.1.0]hexane-3,6-diyl or 1,4 triptycene. In ring class group, any —CH₂— can be optionally replaced by —O—, any —CH═ can be optionally replaced by —N═, and any —H can be optionally replaced by a halogen atom, —CN, —NO₂, —NC, —N═C═S, a silyl group with one to three substituted groups that are alkyl groups of 1 to 4 carbons or phenyl group, a straight-chain alkyl group of 1 to 10 carbons or a branched-chain alkyl group, or a haloalkyl group of 1 to 10 carbons, and any —CH₂— in the alkyl group can be optionally replaced by —O—, —CO—, —COO—, —OCO, —OCOO—, —CH═CH—, or —C≡C—.

In the aforementioned Formula (I), Y in the photopolymerizable compound (B) is selected from a group consisting of the divalent group having a structure of Formulas (I-6) to (I-30):

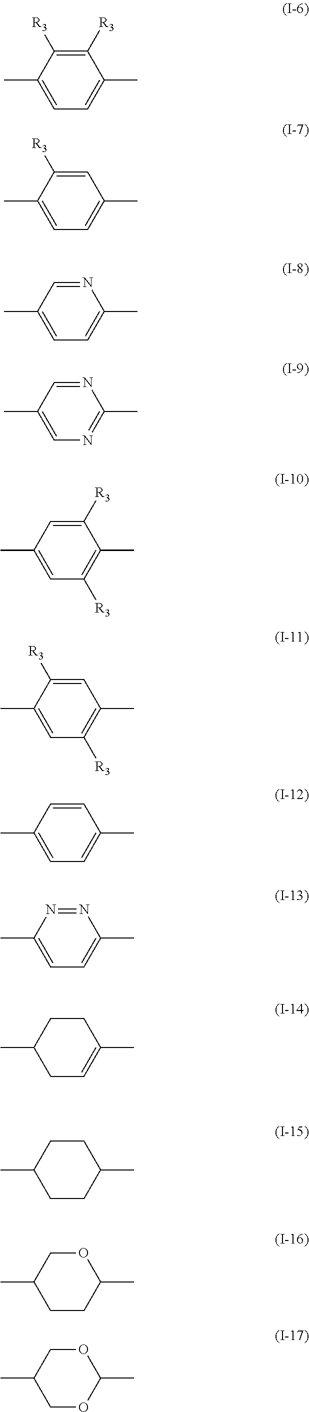

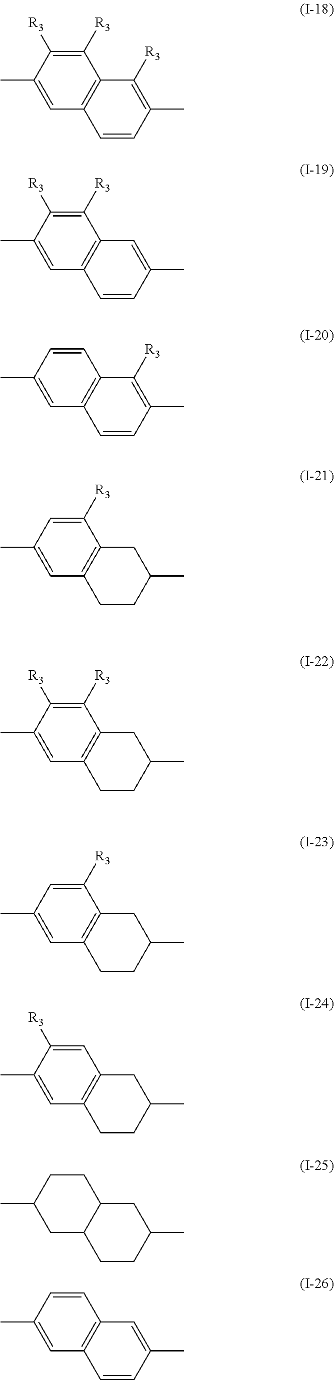

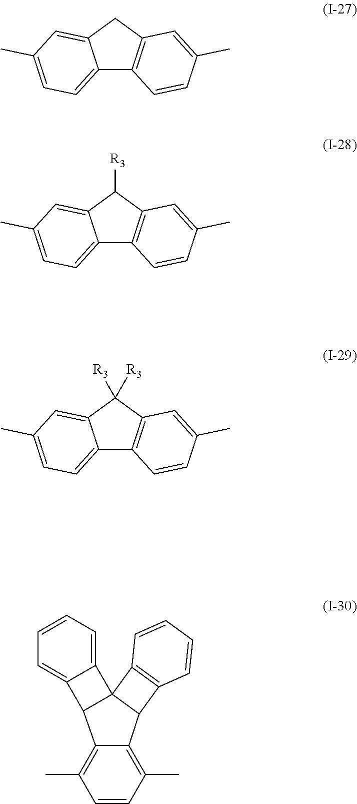

In the Formulas (I-6) to (I-30), R₃ can represent a halogen atom, an alkyl group of 1 to 3 carbons, an alkoxy group of 1 to 3 carbons or a haloalkyl group of 1 to 3 carbons.

The aforementioned photopolymerizable compound (B) can be used alone or in a combination of two or more.

Preferably, the photopolymerizable compound (B) can include but is not limited to the compound having a structure of Formulas (I-31) to (I-42):

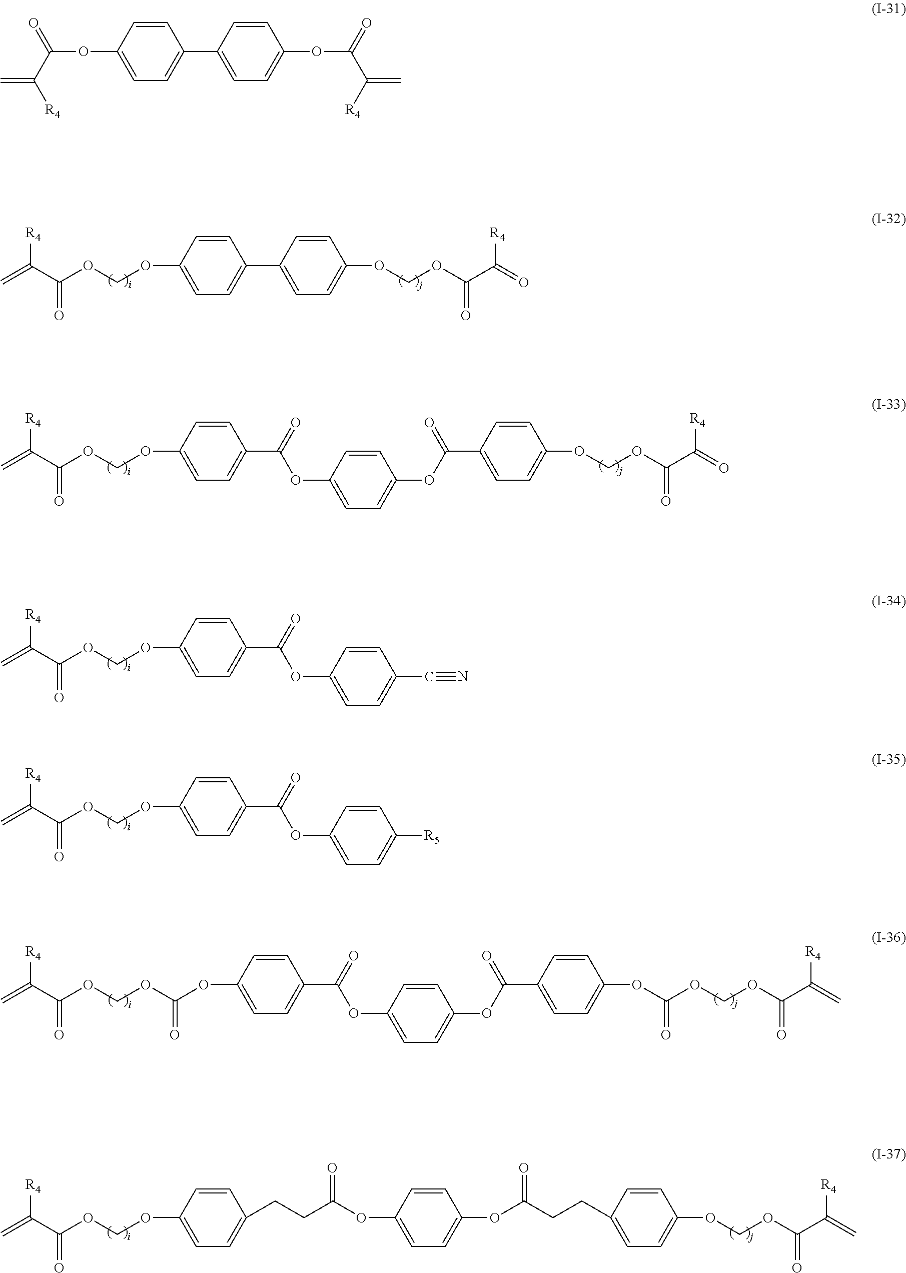

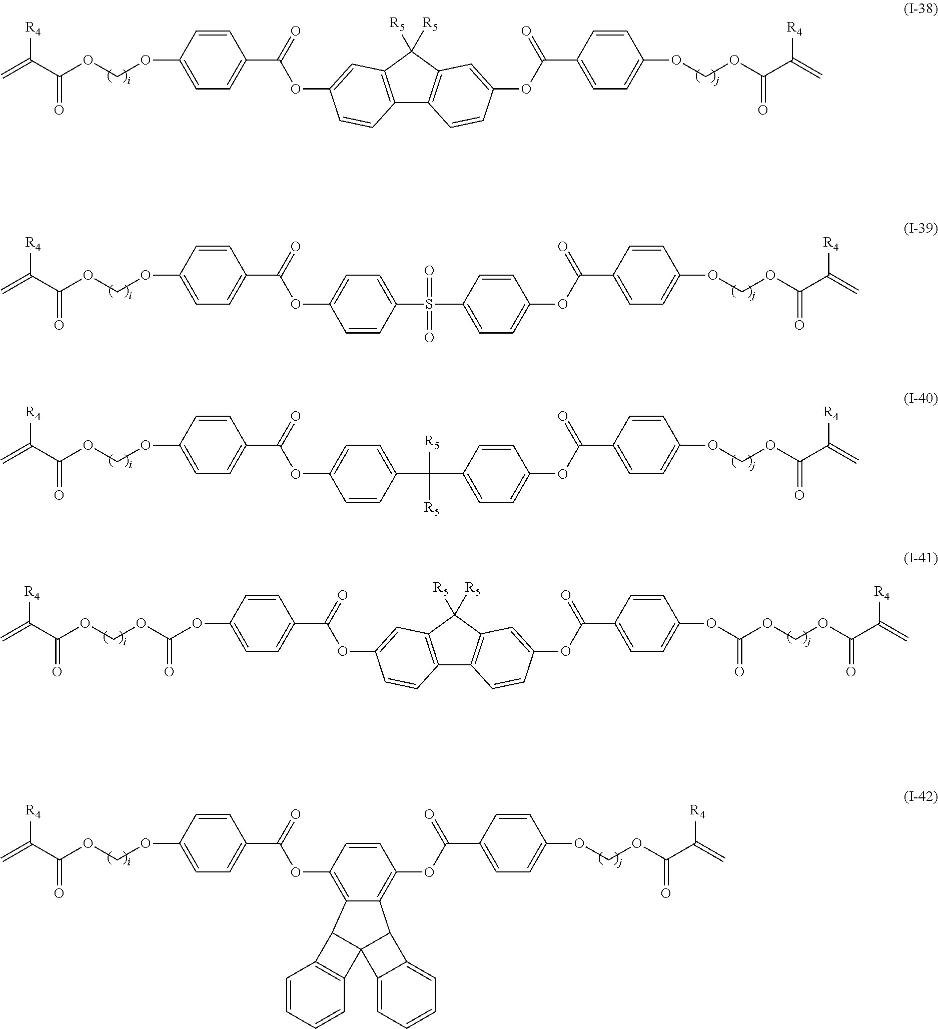

In the Formulas (I-31) to (I-42), R₄ can respectively be a hydrogen atom or a methyl group, and R₅ can independently represent a hydrogen atom, a halogen atom, a methyl group, —CF₃, —OCH₃, a phenyl group, or a saturated or unsaturated hydrocarbon ring of 6 to 15 carbons. The aforementioned saturated or unsaturated hydrocarbon ring is formed by two R₅ bonded on the same carbon atom to form a saturated or an unsaturated hydrocarbon ring of 6 to 15 carbons. The i and j can represent an integer of 1 to 20 independently.

Preferably, the photopolymerizable compound (B) can include but is not limited to the compound having a structure of Formulas (I-43) to (I-97):

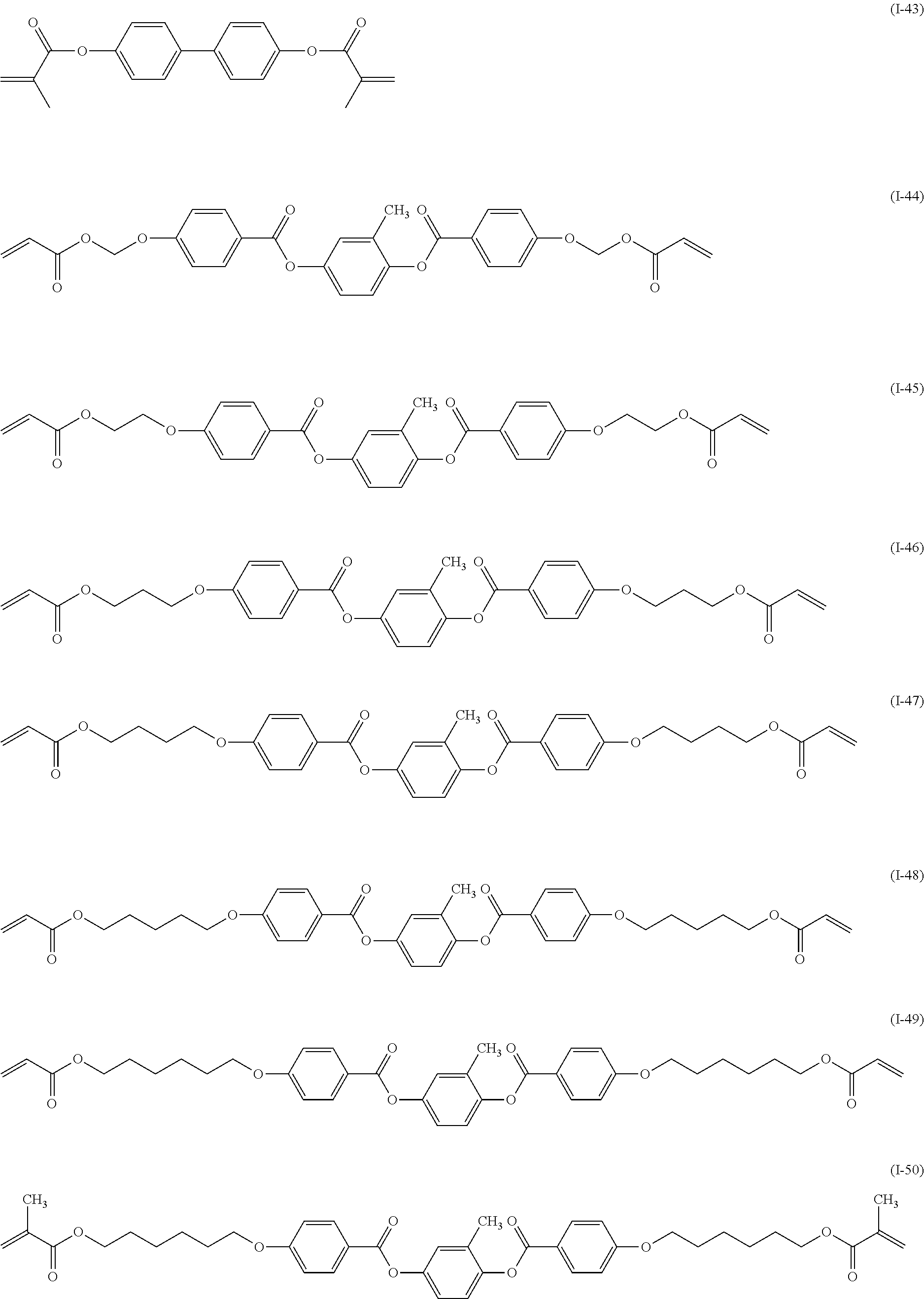

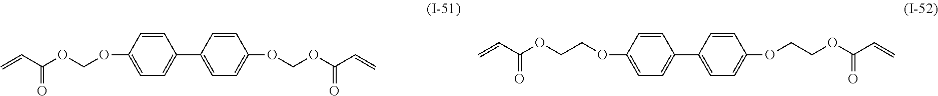 [SMILES: C=CC(=O)OCOc1ccc(-c2ccc(OCOC(=O)C=C)cc2)cc1 ; C=CC(=O)OCCOc1ccc(-c2ccc(OCCOC(=O)C=C)cc2)cc1]

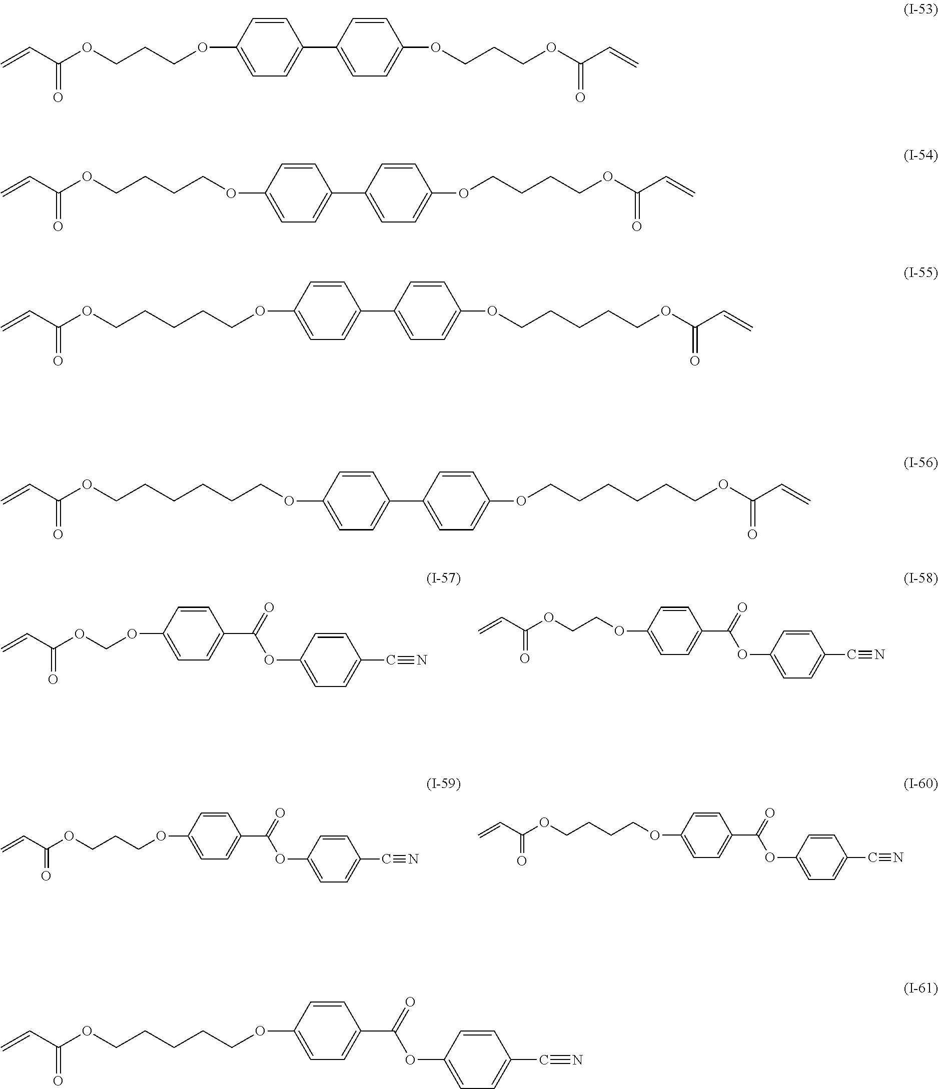

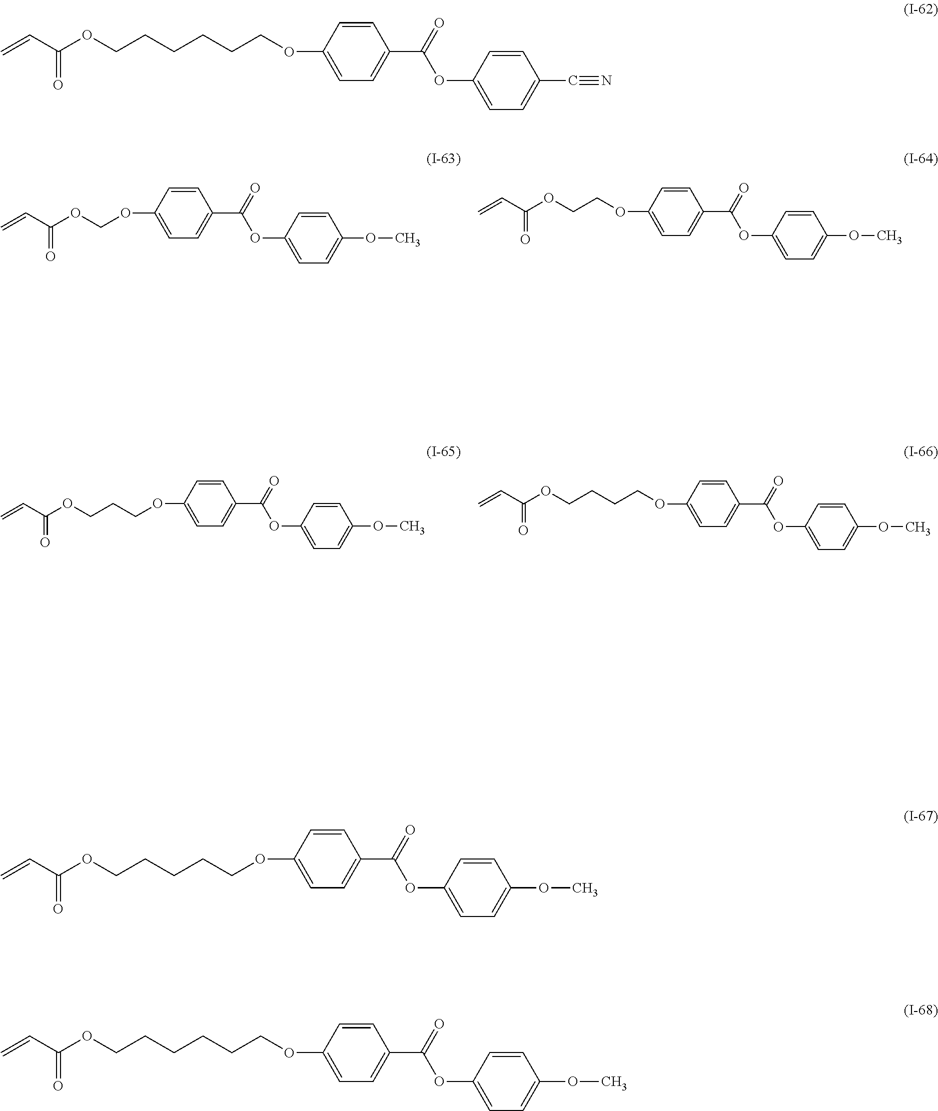

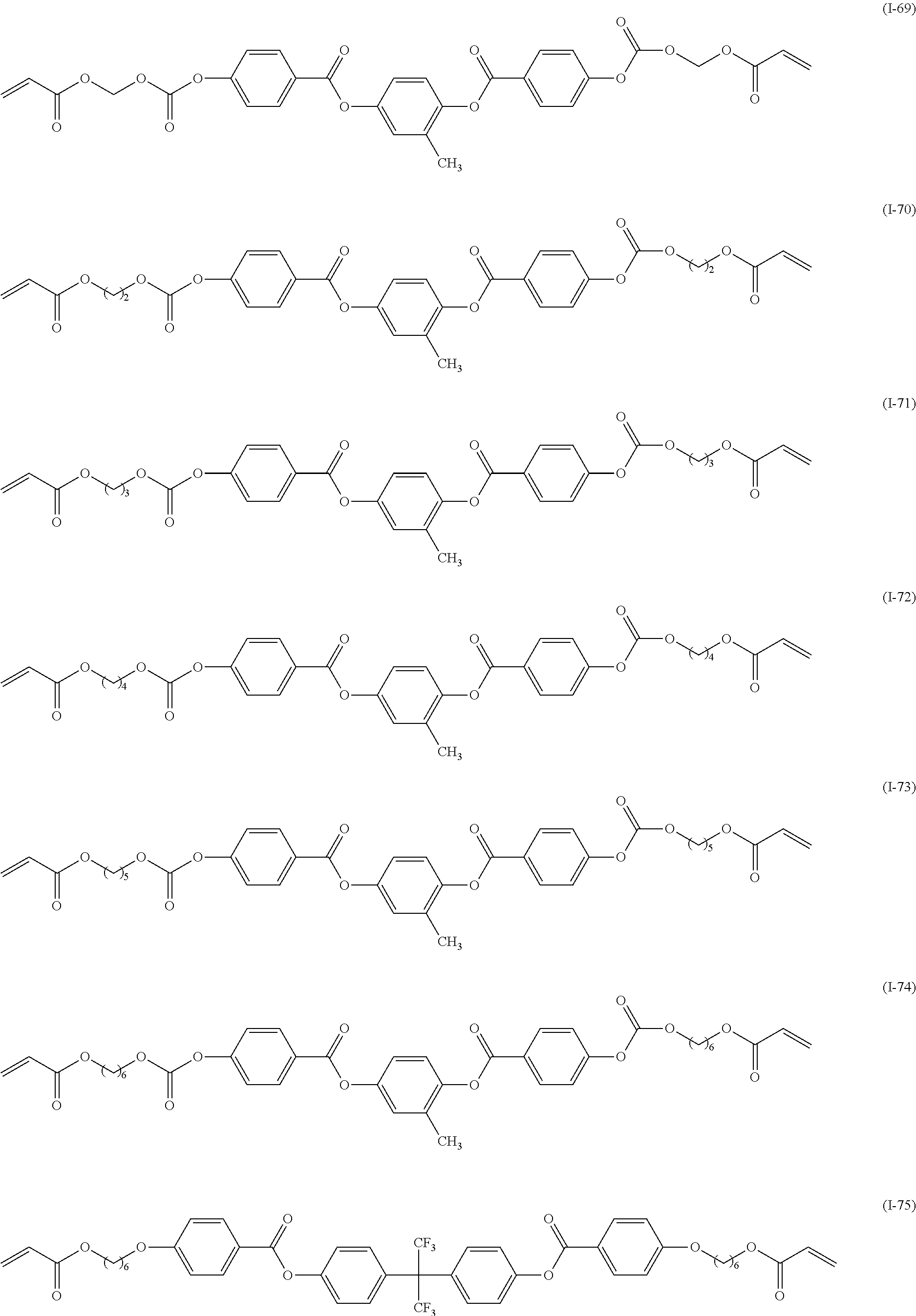

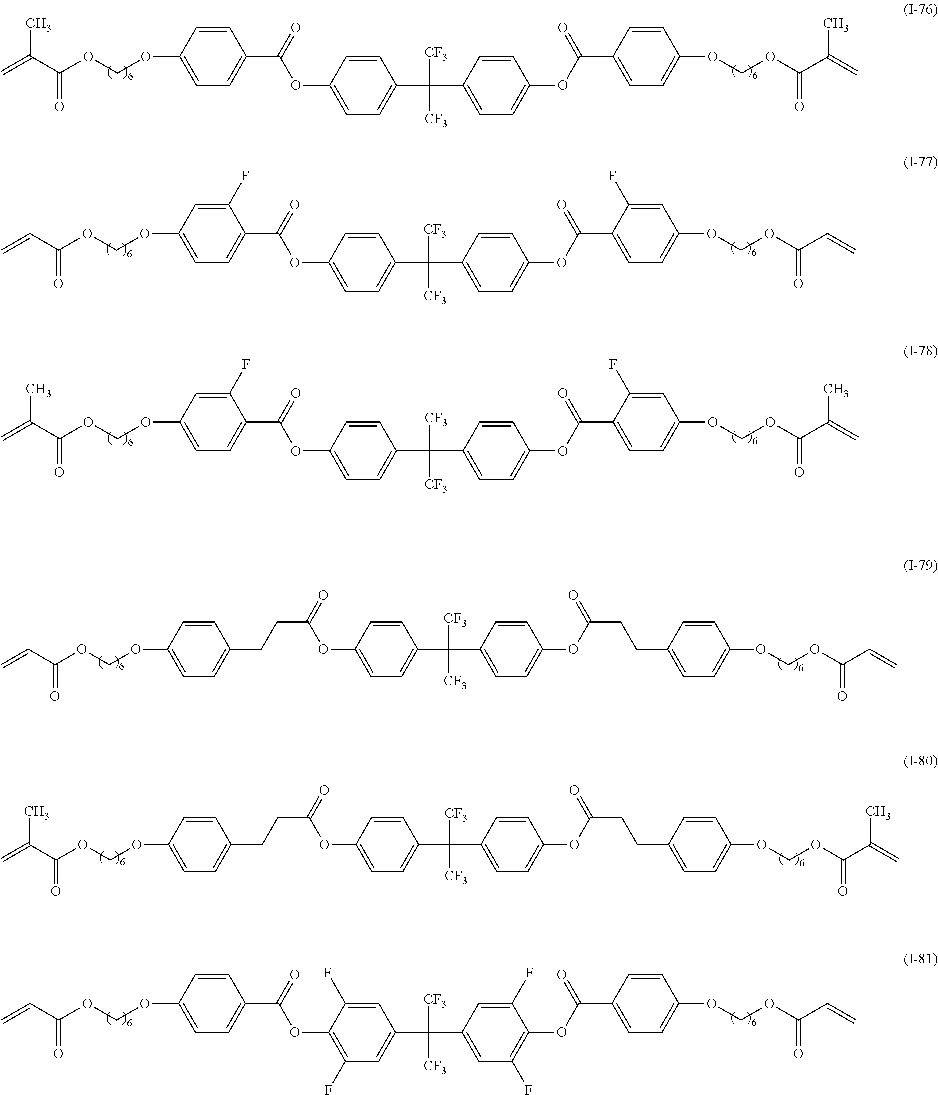

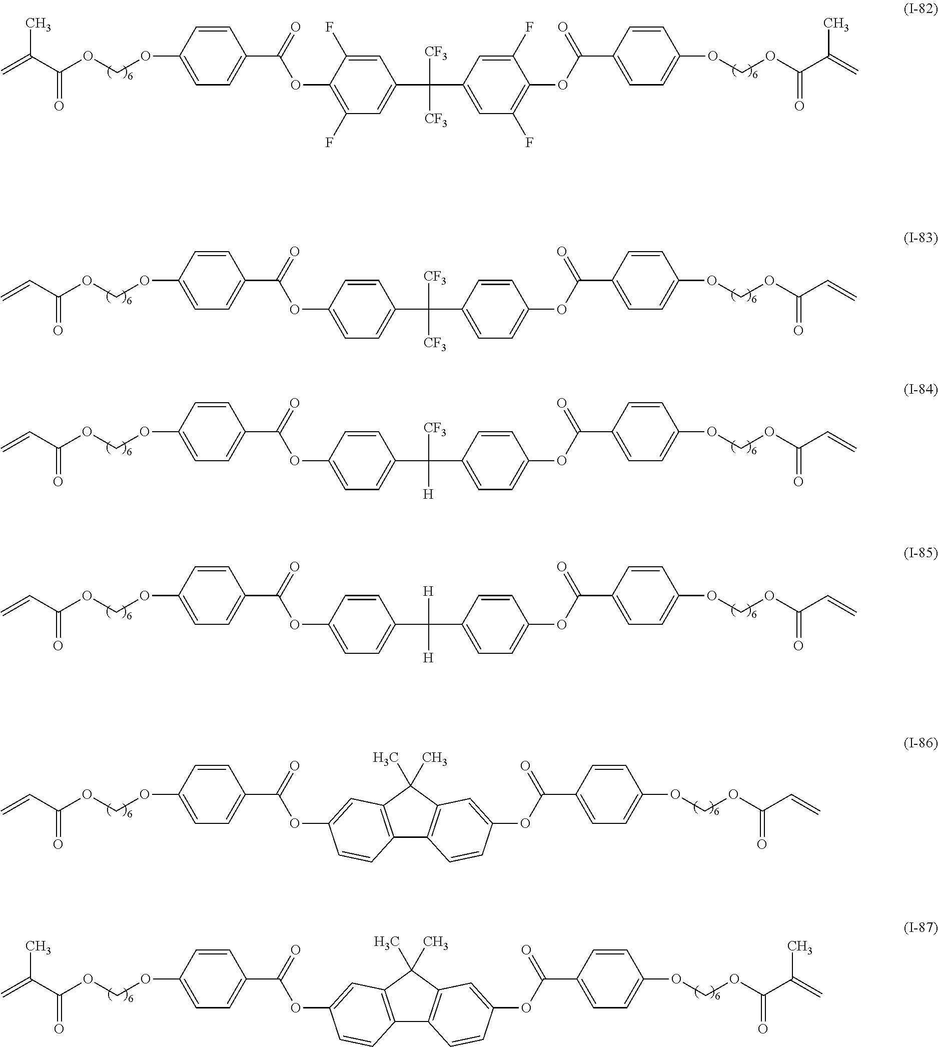

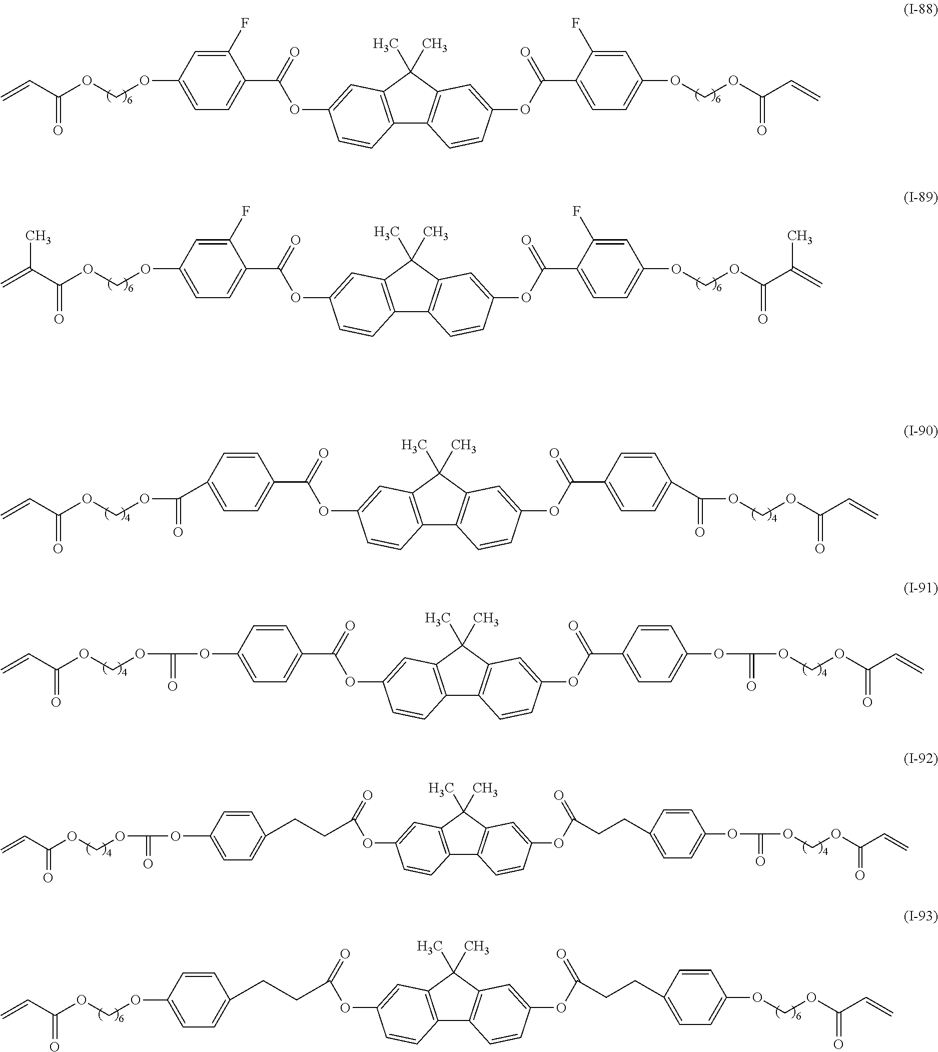

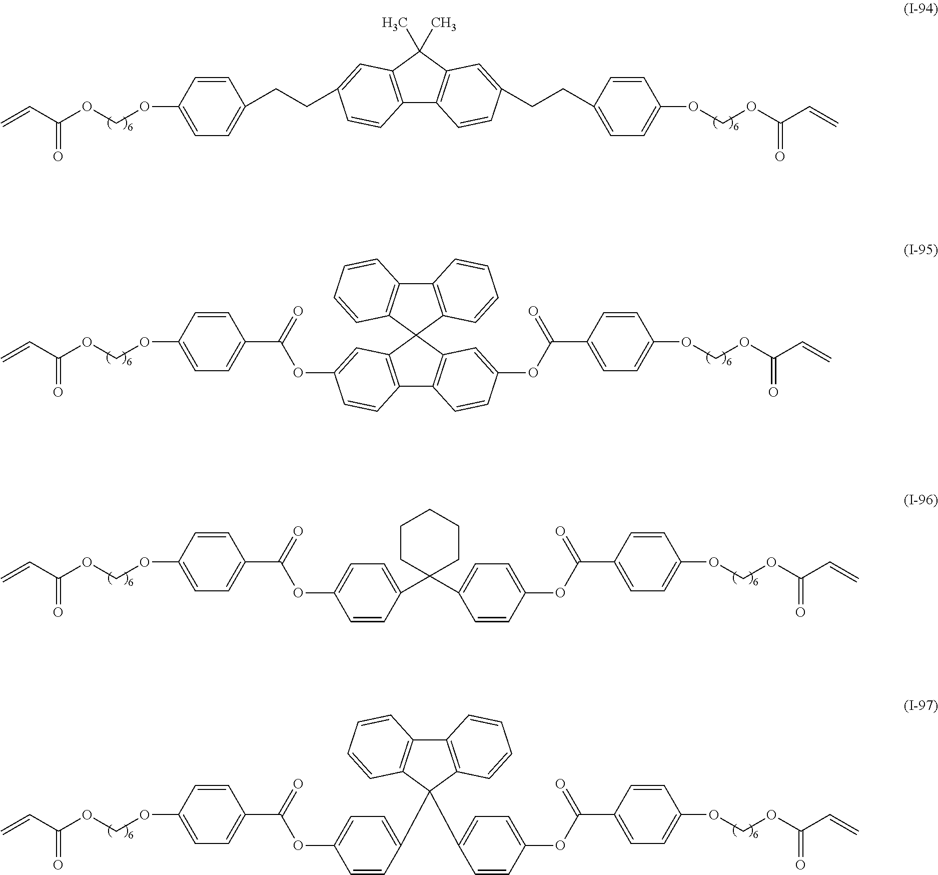

The photopolymerizable compound (B) is preferably the same as the aforementioned compound having a structure of Formulas (I-44) to (I-50) or (I-69) to (I-97). When the photopolymerizable compound (B) contains the aforementioned compounds, the liquid crystal alignment agent has a lower ion density.

Based on the an amount of the polymer composition (A) as 100 parts by weight, an amount of the photopolymerizable compound (B) is 5 parts by weight to 30 parts by weight, preferably is 8 parts by weight to 25 parts by weight, and more preferably is 10 parts by weight to 20 parts by weight.

If the liquid crystal alignment agent does not include photopolymerizable compound (B), the prepared liquid crystal alignment agent still has the defect of exceeding ion density.

### Solvent (C)

The solvent (C) of the present invention preferably is selected from the group consisting of N-methyl-2-pyrrolidone (NMP), γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylacetamide or the like. The solvent (C) can be used alone or in a combination thereof.

### Addictive (D)

Without departing from the efficiency of the present invention, the liquid crystal alignment agent can selectively included an addictive (D). The addictive (D) is an epoxy compound or a silane compound containing a functional group. The addictive (C) can enhance the adhesion between the liquid crystal alignment film and the surface of the substrate. The addictive (D) can be used alone or in a combination of two or more.

The epoxy compound can include but is not limited to ethylene glycol diglycidyl ether, polyethylene glycol diglycidyl ether, propylene glycol diglycidyl ether, triethylene glycol diglycidyl ether, polyethylene glycol diglycidyl ether, neopentyl ethylene glycol dimethyl ether, 1,6-hexanediol diglycidyl ether, glycerol diglycidyl ether, 2,2-dibromo neopentyl glycol diglycidyl ether, 1,3,5,6-tetraepoxypropyl-2,4-hexanediol, N,N,N′,N′-tetraepoxypropyl-m-xylene diamine, 1,3-bis(N,N-diglycidylaminomethylpropyl)cyclohexane, N,N,N′,N′-tetraglycidyl-4,4′-diaminobiphenylmethane, N,N-epoxypropyl-p-epoxy propoxyaniline, 3-(N-allyl-N-epoxypropyl)aminopropyl trimethoxysilane, 3-(N, N-diglycidyl propyl)aminopropyl trimethoxysilane and the like.

Based on the an amount of the polymer composition (A) as 100 parts by weight, an amount of the epoxide compound is generally lower than 40 parts by weight, and preferably is lower than 0.1 parts by weight to 30 parts by weight.

The silane compound containing a functional group can include but is not limited to 3-aminopropyl trimethoxysilane, 3-aminopropyl triethoxysilane, 2-aminopropyl trimethoxysilane, 2-aminopropyl triethoxysilane, N-2-(aminoethyl)-3-aminopropyl trimethoxysilane, N-2-(aminoethyl)-3-aminopropylmethyl dimethoxysilane, 3-ureidopropyl trimethoxysilane, 3-ureidopropyl triethoxysilane, N-ethoxycarbonyl-3-amino propyl trimethoxysilane, N-ethoxycarbonyl-3-aminopropyl triethoxysilane, N-triethoxysilanepropyl triethylenetriamine, N-trimethoxysilanepropyl triethylenetriamine, 10-trimethoxysilane-1,4,7-triazinedecane, 10-triethoxysilane-1,4,7-triazinedecane, 9-trimethoxysilane-3,6-diazinenonylacetate, 9-triethoxysilane-3,6-diazinenonylacetate, N-phenyl-3-aminopropyltrimethoxysilane, N-phenyl-3-aminopropyltriethoxysilane, N-phenyl-3-aminopropyltrimethoxysilane, N-benzyl-3-aminopropyltrimethoxysilane, N-benzyl-3-aminopropyltriethoxysilane, N-bis(epoxyethane)-3-aminopropyltrimethoxysilane, N-bis(epoxyethane)-aminopropyltriethoxysilane or the like.

Based on an amount of the polymer composition (A) as 100 parts by weight, an amount of the silane compound is lower than 10 parts by weight, and preferably is 0.5 parts by weight to 10 parts by weight.

### Producing of Liquid Crystal Alignment Agent

A producing method of the liquid crystal alignment agent of the present invention has no specific limitation. The liquid crystal alignment agent of the present invention is produced by a conventional mixing method. For example, the tetracarboxylic dianhydride component (a) and the diamine component (b) are mixed uniformly to produce the polymer composition (A). And then, the polymer composition (A) and the photopolymerizable compound (B) are added into the solvent (C) at 0° C. to 200° C. in a mixer until all composition are mixed uniformly, and the addictive (D) is selectively added. Preferably, the solvent (C) is added into the polymer composition (A) and the photopolymerizable compound (B) at 20° C. to 60° C.

### Producing of Liquid Crystal Alignment Film

The producing method of the liquid crystal alignment film of the present invention includes the following steps. The aforementioned liquid crystal alignment agent is coated on a surface of a substrate to form a precoating layer by a roller coating, a spin coating, a printing coating, an ink-jet printing and the like. Next, a pre-bake treatment, a post-bake treatment and an alignment treatment are subjected to the precoating layer to produce the liquid crystal alignment film.

The purpose of the aforementioned pre-bake treatment is to volatilize the organic solvent in the precoating layer. The pre-bake treatment is generally performed at 30° C. to 120° C., preferably is 40° C. to 110° C., and more preferably is 50° C. to 100° C.

The alignment treatment has no specific limitation. The liquid crystal alignment film is rubbed along a desired direction with a roller that is covered with a cloth made from fibers such as nylon, rayon, and cotton like. The aforementioned alignment treatment is well known rather than focusing or mentioning them in details.

The polymer in the coating film is further subjected to the dehydration ring-closure reaction (imidization) by the post-bake treatment. The temperature of the post-bake treatment is generally 150° C. to 300° C., preferably is 180° C. to 280° C., and more preferably is 200° C. to 250° C.

### Manufacturing Method of Liquid Crystal Display Element

The manufacturing method of liquid crystal display element is well known technology in the field. Hence, the following is briefly described.

Please refer to the FIG. 1, which is a cross-sectional diagram of a liquid crystal display element according to the present invention. In a preferable embodiment, the liquid crystal display element 100 of the present invention contains a first unit 110, a second unit 120 and a liquid crystal 130, the second unit 120 is spaced apart opposite the first unit 110, and the liquid crystal 130 is disposed between the first unit 110 and the second unit 120.

The first unit 110 comprises a first substrate 111, a first conductive film 113 and a first liquid crystal alignment film 115. The first conductive film 113 is disposed on a surface of the first substrate 111, and the first liquid crystal alignment film 115 is disposed on the surface of the first conductive film 113.

The second unit 120 comprises a second substrate 121, a second conductive film 123 and a second liquid crystal alignment film 125. The second conductive film 123 is disposed on a surface of the second substrate 121, and the second liquid crystal alignment film 125 is disposed on the surface of the second conductive film 123.

The first substrate 111 and the second substrate 121 are selected from a transparent material and the like. The transparent material can include but is not limited to an alkali-free glass, a soda-lime glass, a hard glass (Pyrex glass), a quartz glass, polyethylene terephthalate, polybutylene terephthalate, polyethersulfone, polycarbonate or the like. The materials of the first conductive film 113 and the second conductive film 123 are selected from tin odide (SnO₂), indium oxide-tin oxide (In₂O₃—SnO₂) and the like.

The first liquid crystal alignment film 115 and the second liquid crystal alignment film 125 respectively are the aforementioned liquid crystal alignment film, which can provide the liquid crystal 130 with a pretilt angle. The liquid crystal 130 is driven by an electric field induced by the first conductive film 113 and the second conductive film 123.

The liquid crystal material of the liquid crystal 130 can be used alone or in a combination of two or more. The liquid crystal material can include but is not limited to diaminobenzene liquid crystal, pyridazine liquid crystal, Shiff Base liquid crystal, azoxy liquid crystal, biphenyl liquid crystal, phenylcyclohezane liquid crystal, ester liquid crystal, terphenyl liquid crystal, biphenylcyclohexane liquid crystal, pyrimidine liquid crystal, dioxane liquid crystal, bicyclooctane liquid crystal, cubane liquid crystal and the like. The liquid crystal material can optionally include cholesterol liquid crystal, such as cholesteryl chloride, cholesteryl nonanoate, cholesteryl carbonate and the like; chiral agent, such as products made by Merck Co. Ltd., and the trade name are C-15 and CB-15; ferroelectric liquid crystal, such as p-decoxylbenzilidene-p-amino-2-methyl butyl cinnamate and the like.

Several embodiments are described below to illustrate the application of the present invention. However, these embodiments are not used for limiting the present invention. For those skilled in the art of the present invention, various variations and modifications can be made without departing from the spirit and scope of the present invention.

### BRIEF DESCRIPTION OF THE DRAWINGS

The invention can be more fully understood by reading the following detailed description of the embodiment, with reference made to the accompanying drawings as follows:

FIG. 1 is a cross-sectional diagram of a liquid crystal display element according to the present invention.

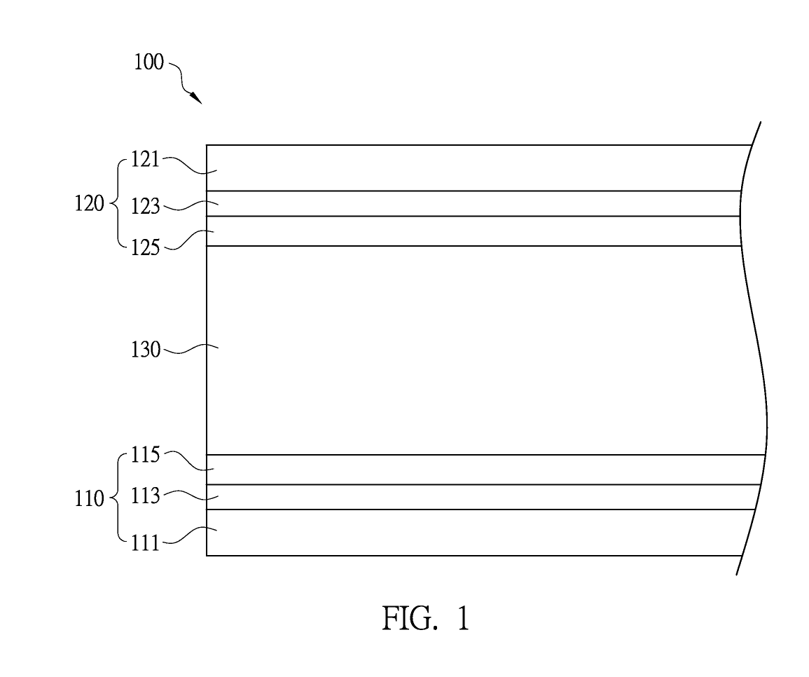

### DETAILED DESCRIPTION

### Producing of the Polymer Composition (A)

The polymer composition (A) was prepared by Synthesis Examples A-1-1 to A-2-10 according to TABLE 1.

### Synthesis Example A-1-1

A 500 mL four-necked conical flask equipped with a nitrogen inlet, a stirrer, a condenser and a thermometer was purged with nitrogen, and the following components were charged to the flask. The aforementioned components comprising 2.28 g (0.015 moles) of diamine compound (b-1-1) as shown in aforementioned Formula (II-6), 3.78 g (0.035 moles) of p-diaminobenzene and 80 g N-methyl-2-pyrrolidone (hereinafter abbreviated to NMP) were stirred to dissolve completely under room temperature (e.g. 25° C.). Next, 10.91 g (0.05 moles) of pyromellitic dianhydride (a-1) and 20 g of NMP were added into the reaction solution and reacted under room temperature (e.g. 25° C.) for 2 hours. After the reaction was terminated, the reaction solution was poured into 1500 mL of water for precipitating the polymer. The filtered and collected polymer was repetitively rinsed by methanol and filtered in three times. And then, the product was dried in a vacuum drier at 60° C., thereby obtaining a polymer (A-1-1). The imidization percentage of the polymer (A-1-1) was determined by using the following evaluation methods and resulted in TABLE 1. The detection method of the imidization percentage was described as follows.

### Synthesis Examples A-1-2 to A-1-5

Synthesis Examples A-1-2 to A-1-5 were practiced with the same method as in Synthesis Example A-1-1 by using different kinds and different amounts of the components of the polymer (A-1-1). The formulations of Synthesis Examples A-1-2 to A-1-5 were also listed in TABLE 1 rather than focusing or mentioning them in detail.

### Synthesis Example A-2-1

A 500 mL four-necked conical flask equipped with a nitrogen inlet, a stirrer, a heater, a condenser and a thermometer were purged with nitrogen, and the following components were charged to the flask. The aforementioned components comprising 2.28 g (0.015 moles) of diamine compound (b-1-1) as shown in aforementioned Formula (II-6) and 3.78 g (0.035 moles) of p-diaminobenzene (b-2-1) and 80 g NMP were stirred to dissolve completely under room temperature (e.g. 25° C.). Next, 10.91 g (0.05 moles) of pyromellitic dianhydride (a-1) and 20 g of NMP were added into the reaction solution and reacted under room temperature (e.g. 25° C.) for 6 hours. And then, 97 g of NMP, 2.55 g of the acetic anhydride and 19.75 g of the pyridine were added into the reaction solution, heated to 60° C. and kept stirring for 2 hours for preceding an imidization reaction. After the reaction was terminated, the reaction solution was poured into 1500 mL of water for precipitating the polymer. The filtered and collected polymer was repetitively rinsed by methanol and filtered in three times. And then, the product was dried in a vacuum drier at 60° C., thereby obtaining a polymer composition (A-2-1). The evaluation result of the imidization percentage of the polymer composition (A-2-1) was shown in TABLE 1.

### Synthesis Examples A-2-2 to A-2-10

Synthesis Examples A-2-2 to A-2-10 were practiced with the same method as in Synthesis Example A-2-1 by using different kinds and different amounts of the components of the polymer composition (A-2-1). The formulations and the evaluation results of Synthesis Examples A-2-2 to A-2-10 were also listed in TABLE 1 and 2 rather than focusing or mentioning them in detail.

### Producing of Liquid Crystal Alignment Agent

The following examples were directed to the preparation of the liquid crystal alignment agents of Examples 1 to 12 and Comparative Examples 1 to 6 according to TABLES 2.

### Example 1

100 parts by weight of the polymer (A-1-1) and 10 parts by weight of photopolymerizable compound (B-1) shown in the aforementioned Formula (I-43) added into 1200 parts by weight of NMP (C-1) and 600 parts by weight of ethylene glycol n-butyl ether (C-2) were stirred and mixed under room temperature (e.g. 25° C.), so as to obtain the liquid crystal alignment agent of Example 1. The resulted liquid crystal alignment agent was determined by using the following evaluation methods and resulted in TABLE 2. The detection method of ion density was described as follows.

### Examples 2 to 12 and Comparative Examples 1 to 6

Examples 2 to 12 and Comparative Examples 1 to 6 were practiced with the same method as in Example 1 by using different kinds and different amounts of the components of the liquid crystal alignment agent. The formulations and evaluation results of Examples 2 to 12 and Comparative Examples 1 to 6 were listed in TABLES 2 rather than focusing or mentioning them in detail.

### Evaluation Methods

### 1. Imidization Percentage

The imidization percentage was referred to a ratio of the imide ring, which was calculated according to the total amount of the number of the amic acid group and the number of the imide ring in the polyimide, and the ratio of the imide ring was represented as percentage.

The polymer composition (A) of Synthesis Examples A-1-1 to A-2-12 was dried under a reduced pressure and then dissolved in an appropriate deuterated solvent (e.g. deuterated dimethylsulfoxide). ¹H-NMR (proton nuclear magnetic resonance) results of the polymer composition (A) were measured under room temperature (e.g. 25° C.) by using tetramethylsilane as a reference standard, and the imidization percentages (%) of the polymer composition (A) were calculated according to Equation (VI) as follow:

$$Imidization Percentage ( \% ) = [ 1 - \frac{Δ 1}{Δ 2 \times α} ] \times 100 \% \qquad ( VI )$$

In the Equation (VI), the Δ1 was referred to a peak area produced by chemical shift around 10 ppm of the proton of the NH group, the Δ2 was referred to a peak area of other protons, and the α was referred to a number ratio of the proton number of NH group to the number of other protons in the polyamic acid precursor of those polymers.

### 2. Ion Density

The ion density of liquid crystal display element of Examples 1 to 12 and Comparative Examples 1 to 6 was measured by using the Electrical Measuring Machine (Model No. 6254, manufactured by TOYO Corporation). Its measurement conditions are an applied voltage 1.7 volts and in the form of triangular waveform with the frequency 0.01 Hz. Then, in the current-voltage waveform, ion density (units pC/cm²) can be measured by the calculation of peak area between 0 and 1 volt, and evaluated according to the following criterion:

⊚: ion density<50;

•: 50≦ion density<100;

Δ: 100≦ion density<200;

x: 200≦ion density.

According to TABLES 1 and 2, when the liquid crystal alignment agent includes the photopolymerizable compound (B) and the diamine component (b) of the polymer composition (A) includes the diamine compound containing carboxyl group (b-1), the liquid crystal alignment agent can reduce the ion density.

In addition, when the imidization percentage (%) of the polymer composition (A) is 30% to 90%, the liquid crystal alignment agent had a lower ion density.

Furthermore, when the photopolymerizable compound (B) which used in the liquid crystal alignment agent includes the aforementioned compounds having structures of Formulas (I-44) to (I-50) or (I-69) to (I-97), the liquid crystal alignment agent also has a lower ion density.

It should be supplemented that, although specific compounds, components, reaction conditions, processes, evaluation methods or specific equipments are described as examples of the present invention, for illustrating the liquid crystal alignment agent, liquid crystal alignment film and liquid crystal display element of the present invention. However, as is understood by a person skilled in the art instead of limiting to the aforementioned examples, the liquid crystal alignment agent, liquid crystal alignment film and liquid crystal display element of the present invention also can be manufactured by using other compounds, components, reaction conditions, processes, evaluation methods and equipments without departing from the spirit and scope of the present invention.

Although the present invention has been described in considerable detail with reference to certain embodiments thereof, other embodiments are possible. Therefore, the spirit and scope of the appended claims should not be limited to the description of the embodiments contained herein.

TABLE 1

| | | | Synthesis Examples | | | | | | | | | | | | | | | | |
|---|---|---|---|---|---|---|---|---|---|---|---|---|---|---|---|---|---|---|---|
| Components | | | A- | A- | A- | A- | A- | A- | A- | A- | A- | A- | A- | A- | A- | A- | A- | A- | A- |
| (mole %) | | | 1-1 | 1-2 | 1-3 | 1-4 | 1-5 | 2-1 | 2-2 | 2-3 | 2-4 | 2-5 | 2-6 | 2-7 | 2-8 | 2-9 | 2-10 | 2-11 | 2-12 |
| Tetracarboxylic | | a-1 | 100 | | | 100 | | 100 | | | 100 | | | 50 | | | | 50 | |
| Dianhydride | | a-2 | | 100 | 50 | | | | 100 | 50 | | | 100 | 50 | 100 | | 100 | | |
| Component (a) | | a-3 | | | 50 | | 100 | | | 50 | | 100 | | | | 100 | | 50 | 100 |
| Diamine | Diamine | b-1-1 | 30 | | | | | 30 | | | | | | 5 | | | | | 50 |
| Component | Compound | b-1-2 | | 20 | | | | | 20 | | | 50 | | 30 | | 45 | | | |
| (b) | (b-1) | b-1-3 | | | 40 | 30 | | | | 40 | 30 | | | | 55 | | | | |
| | | b-1-4 | | | | 30 | | | | | 30 | | 25 | | | | | | |
| | Diamine | b-2-1 | 70 | | | 25 | | 70 | | | 25 | 45 | | 40 | | | 20 | | 20 |
| | Compound | b-2-2 | | 75 | | | 95 | | 75 | | | 6 | | | 15 | 50 | 75 | 40 | |
| | (b-2) | b-2-3 | | | 40 | | | | | 40 | | | 55 | | | | | 40 | |
| | | b-2-4 | | 5 | | 15 | 5 | | 5 | | 15 | | 20 | | 30 | | 5 | | |
| | | b-2-5 | | | 20 | | | | | 20 | | | | | | 5 | | 20 | 20 |
| | | b-2-6 | | | | | | | | | | | | 25 | | | | | 10 |

| | | | | | | | | | | | | | | | | | |
|---|---|---|---|---|---|---|---|---|---|---|---|---|---|---|---|---|---|
| Imidization percentage (%) | 0 | 0 | 0 | 0 | 0 | 12 | 23 | 28 | 30 | 42 | 51 | 63 | 81 | 90 | 95 | 62 | 65 |

a-1 Tetracarboxylic dianhydride
a-2 1,2,3,4-cyclobutane tetracarboxylic dianhydride
a-3 2,3,5-tricarboxycyclopentyl acetic dianhydride
b-1-1 The diamine compound having a structure of Formula (II-6)
b-1-2 The diamine compound having a structure of Formula (II-8)
b-1-3 The diamine compound having a structure of Formula (II-9)
b-1-4 The diamine compound having a structure of Formula (II-16)
b-2-1 p-diaminobenzene
b-2-2 4,4′-diaminodiphenyl methane
b-2-3 4,4′-diaminodiphenyl ether
b-2-4 The diamine compound having a structure of Formula (V-29)
b-2-5 The diamine compound having a structureof Formula (V-1-2)
b-2-6 The diamine compound having a structureof Formula (V-1-5)

TABLE 2

| Components | | Examples | | | | | | | | | | | | Comparable Examples | | | | | |
|---|---|---|---|---|---|---|---|---|---|---|---|---|---|---|---|---|---|---|---|
| (parts by weight) | | 1 | 2 | 3 | 4 | 5 | 6 | 7 | 8 | 9 | 10 | 11 | 12 | 1 | 2 | 3 | 4 | 5 | 6 |
| Polymer | A-1-1 | 100 | | | | | | | | | | | | 100 | | | | | |
| Compo- | A-1-2 | | 100 | | | | | | | | | | | | | | | | |
| sition | A-1-3 | | | 100 | | | | | | | | | | | | | | | |
| (A) | A-1-4 | | | | 100 | | | | | | | | | | | | | | |
| | A-1-5 | | | | | | | | | | | | | | 100 | | | | |
| | A-2-1 | | | | | 100 | | | | | | | | | | | | | |
| | A-2-2 | | | | | | 100 | | | | | | | | | | | | |
| | A-2-3 | | | | | | | 100 | | | | | | | | | | | |
| | A-2-4 | | | | | | | | 100 | | | | | | | | | | |
| | A-2-5 | | | | | | | | | 100 | | | | | | | 100 | | |
| | A-2-6 | | | | | | | | | | 100 | | | | | | | | |
| | A-2-7 | | | | | | | | | | | 100 | | | | | | | |
| | A-2-8 | | | | | | | | | | | | 50 | | | | | | |
| | A-2-9 | | | | | | | | | | | | 50 | | | | | | |
| | A-2-10 | | | | | | | | | | | | | | | 100 | | | |
| | A-2-11 | | | | | | | | | | | | | | | | | 100 | |
| | A-2-12 | | | | | | | | | | | | | | | | | | 100 |
| Photo- | B-1 | 10 | | | | | | 10 | | | | 3 | | | | | | | |
| poly- | B-2 | | 5 | | | 5 | | 5 | | | 20 | | | | 5 | | | | |
| merizable | B-3 | | | 12 | | | | | | | | | | | | | | 12 | |
| Com- | B-4 | | | | 15 | | | | 8 | | | 25 | | | | | | | |
| pound | B-5 | | | | | 20 | | | | 20 | | | | | | | | | |
| (B) | B-6 | | | | | | 30 | | | 5 | | | 15 | | | | | | |
| Solvent | C-1 | 1200 | | 800 | 700 | | 1000 | 900 | 850 | | | | | 1200 | | 800 | 1400 | 800 | 420 |
| (C) | C-2 | 600 | 1600 | | 700 | 1500 | | 300 | 850 | | 800 | | 1000 | 600 | 1600 | | | | 700 |
| | C-3 | | | 1000 | | 100 | | 300 | | | 600 | 1500 | | | | | | 1000 | |
| | C-4 | | | | | | 600 | | | | | | 350 | | | | | | 280 |
| Addictive | D-1 | | | | | | | | | 5 | | 2 | | | | | 5 | | |
| (D) | D-2 | | | | | 10 | | | | | | 3 | | | | | | | |
| Evaluation | Ion | ◯ | ◯ | ⊚ | ⊚ | ⊚ | ⊚ | ◯ | ⊚ | ⊚ | ⊚ | ⊚ | ⊚ | X | X | X | X | X | X |
| result | density | | | | | | | | | | | | | | | | | | |

B-1 The photopolymeriable compound having a structure of Formula (I-43)
B-2 The photopolymeriable compound having a structure of Formula (I-53)
B-3 The photopolymeriable compound having a structure of Formula (I-48)
B-4 The photopolymeriable compound having a structure of Formula (I-69)
B-5 The photopolymeriable compound having a structure of Formula (I-76)
B-6 The photopolymeriable compound having a structure of Formula (I-87)
C-1 N-methyl-2-pyrrolidinone
C-2 Ethylene glycol n-butyl ether
C-3 N,N-dimethylacetamide
D-1 N,N,N′,N′-tetraglycidyl-4,4′-diaminobiphenylmethane
D-2 N,N-epoxypropyl-p-epoxy propoxyaniline

What is claimed is:

1. A liquid crystal alignment agent, comprising:
a polymer composition (A), obtained by reacting a mixture that includes a tetracarboxylic dianhydride component (a) and a diamine component (b), wherein the diamine components (b) contains at least one diamine compound having carboxyl group (b-1) and an other diamine compound (b-2);
the photopolymerizable compound (B) having a structure of Formula (I): 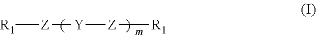
In the Formula (I), R₁ independently is a polymerizable functional group having structures of Formulas (I-1) to (I-5), a hydrogen atom, a halogen atom, —CN, —CF₃, —CF₂H, —CFH₂, —OCF₃, —OCF₂H, —N═C═O, —N═C═S or an alkyl group of 1 to 20 carbons, wherein any —CH₂— is optionally replaced by —O—, —S—, —SO₂—, —CO—, —COO—, —OCO—, —CH═CH—, —CF═CF— or —C≡C—, and any hydrogen atom is optionally replaced by a halogen atom or —CN; Y independently is a divalent group containing a saturated or an unsaturated separated ring, a condensed ring or a spiro ring of 3 to 20 carbons, wherein any —CH₂— is optionally replaced by —O—, any —CH═ is optionally replaced by —N═, and any —H is optionally replaced by a halogen atom, —CN, —NO₂, —NC, —N═C═O, —N═C═S, a silyl group, a straight-chain alkyl group of 1 to 10 carbons, a branched-chain alkyl group of 1 to 10 carbons, or a haloalkyl group of 1 to 10 carbons, wherein —CH₂— in the alkyl group is optionally replaced by —O—, —CO—, —COO—, —OCO—, —OCOO—, —CH═CH— or —C≡C—; Z is an alkylene group of 1 to 20 carbons, wherein —CH₂— is optionally replaced by —O—, —S—, —SO₂—, —CO—, —COO—, —OCO—, —OCOO—, —CH═CH—, —CF═CF—, —CH═N—, —N═CH—, —N═N—, —N(O)═N— or —C≡C—, and any —H is optionally replaced by a halogen atom, an alkyl group of 1 to 10 carbons or a haloalkyl group of 1 to 10 carbons; m is an integer of 1 to 6, and when m is an integer of 2 to 6, the plural —Y—Z— can be the same or different. 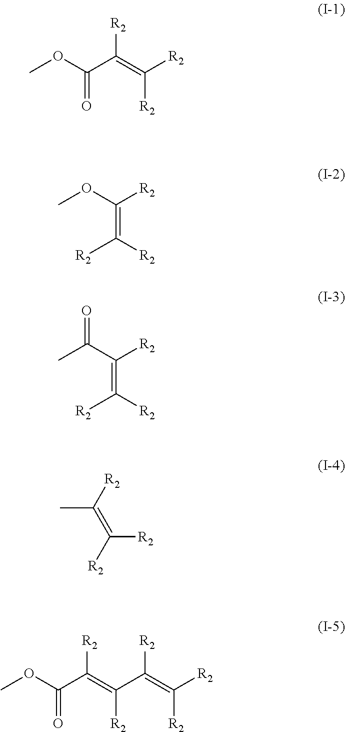
In the Formulas (I-1) to (I-5), R₂ is a hydrogen atom, a halogen atom, —CF₃ or an alkyl group of 1 to 5 carbons; and
a solvent (C).

2. The liquid crystal alignment agent of claim 1, wherein the diamine compound containing carboxyl group (b-1) has a structure of Formula (II): 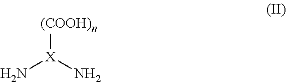
In the Formula (II), X is an aromatic organic group of 6 to 30 carbons, and n is an integer of 1 to 4.

3. The liquid crystal alignment agent of claim 2, wherein the diamine compound containing carboxyl group (b-1) is selected from the group consisting of a structure of Formulas (II-1) to (II-5): 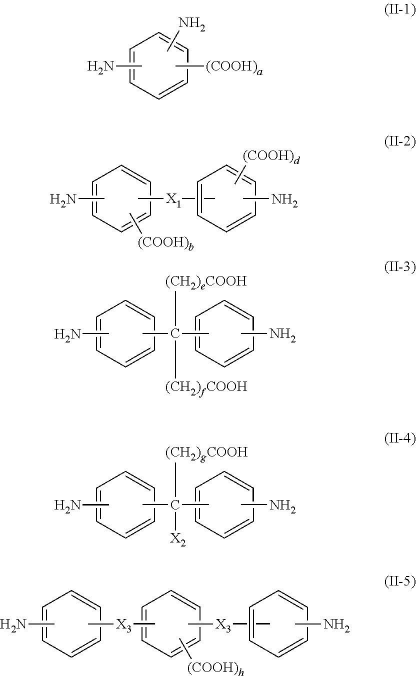
In the Formulas (II-1) to (II-5), X₁ and X₃ independently are a single bond, —CH₂—, —C₂H₄—, —C(CH₃)₂—, —CF—, —C(CF₃)₂—, —O—, —CO—, —NH—, —N(CH₃)—, —CONH—, —NHCO—, —CH₂O—, —OCH₂—, —COO—, —OCO—, —CON(CH₃)— or —N(CH₃)CO—; X₂ is a straight-chain alkyl group or a branched-chain alkyl group of 1 to 5 carbons; a and h independently are an integer of 1 to 4; b and d independently are an integer of 0 to 4, and (b+d) is an integer of 1 to 4; e, f and g independently are an integer of 1 to 5.

4. The liquid crystal alignment agent of claim 1, wherein at least one of R₁ of the photopolymerizable compound (B) is selected from the group consisting of the polymerizable functional groups having a structure of Formulas (I-1) to (I-3).

5. The liquid crystal alignment agent of claim 1, wherein Y in the photopolymerizable compound (B) independently is a divalent group containing 1,4-cyclohexylene, 1,4-cyclohexenylene, 1,4-phenylene, naphthalene-2,6-diyl, tetrahydronaphthalene-2,6-diyl, fluorene-2,7-diyl, bicyclo[2.2.2]octane-1,4-diyl, bicyclo[3.1.0]hexane-3,6-diyl or triptycene-1,4-diyl, wherein any —CH₂— is optionally replaced by —O—, any —CH═ is optionally replaced by —N═, and any —H is optionally replaced by a halogen atom, —CN—, NO₂—, —NC, —N═C═S, a silyl group with one to three substituted groups that are alkyl groups of 1 to 4 carbons or phenyl group, a straight-chain alkyl group or a branched-chain alkyl group of 1 to 10 carbons, or a haloalkyl group of 1 to 10 carbons, wherein any —CH₂ in the alkyl group is optionally replaced by —O—, —CO—, —COO—, —OCO, —OCOO—, —CH═CH—, or —C≡C—.

6. The liquid crystal alignment agent of claim 1, wherein Y in the photopolymerizable compound (B) is selected from a group consisting of the divalent group having a structure of Formulas (I-6) to (I-30): 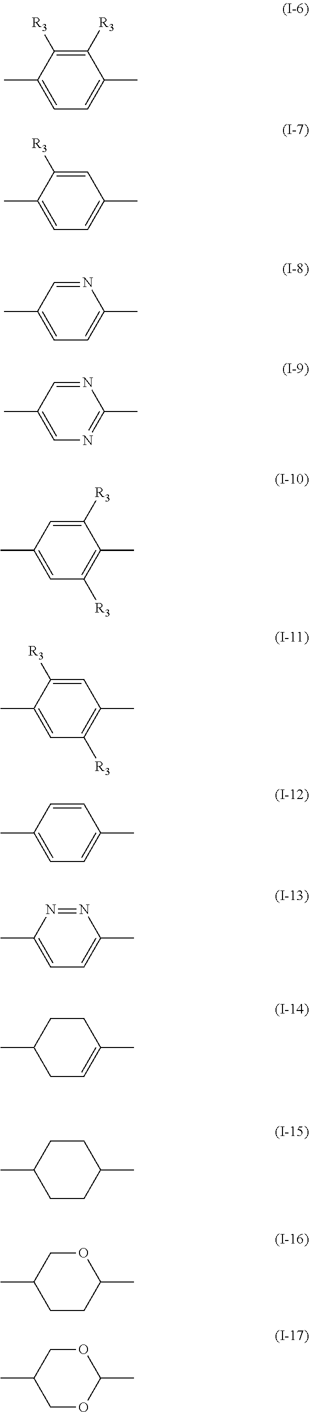 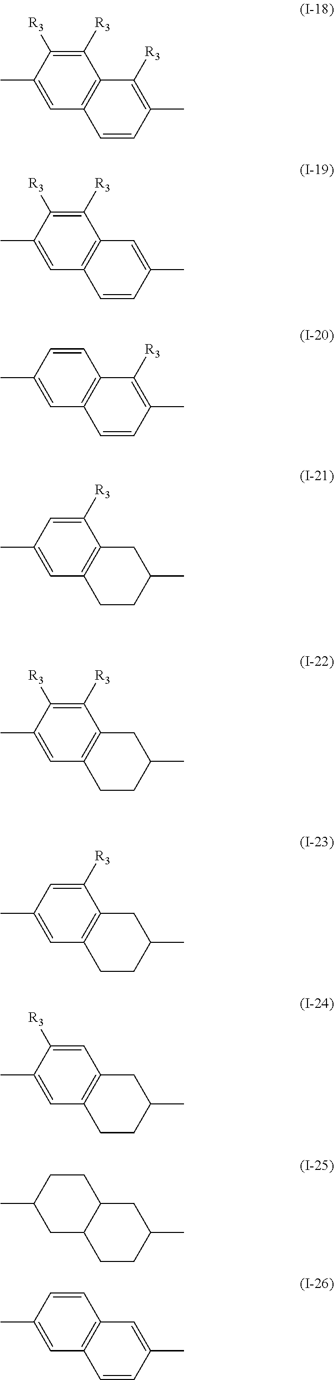 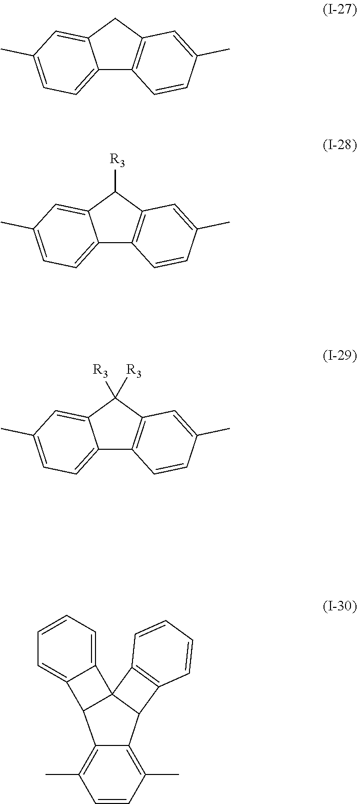
In the Formulas (I-6) to (I-30), R₃ is a halogen atom, an alkyl group of 1 to 3 carbons, an alkoxy group of 1 to 3 carbons or a haloalkyl group of 1 to 3 carbons.

7. The liquid crystal alignment agent of claim 1, wherein the photopolymerizable compound (B) is selected from a group consisting of a structure of Formulas (I-31) to (I-42): 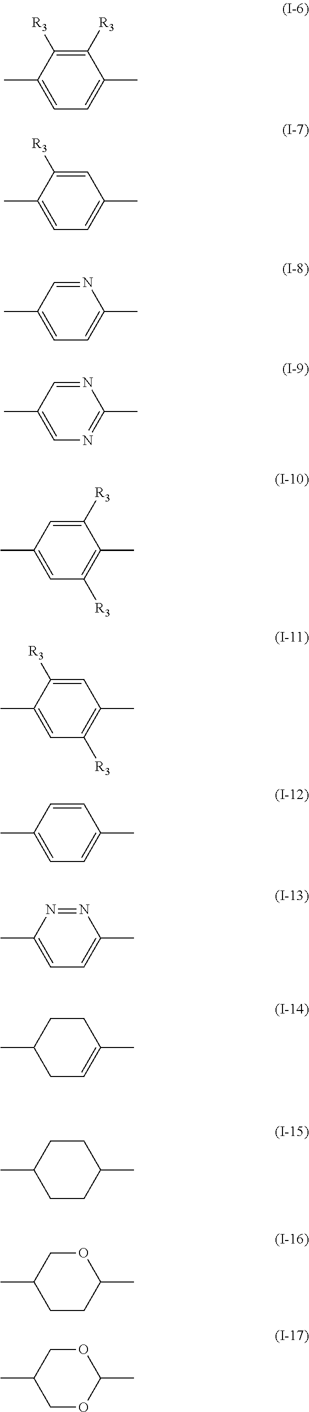 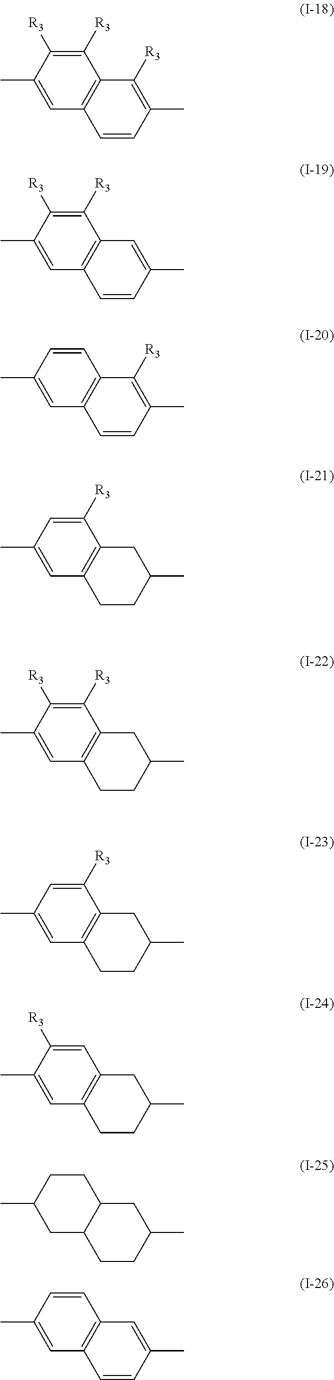 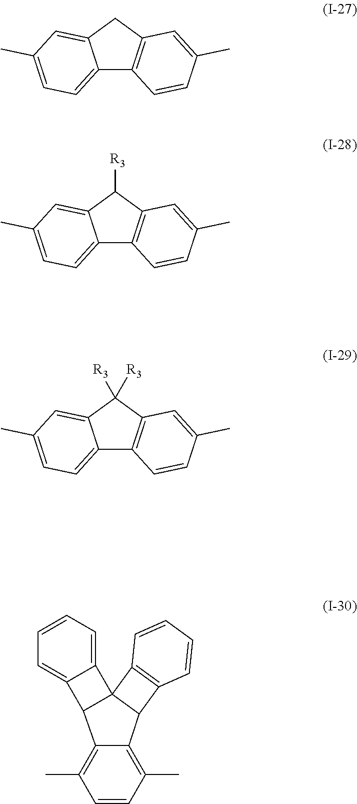
In the Formulas (I-31) to (I-42), R₄ independently is a hydrogen atom or a methyl group, and R₅ independently is a hydrogen atom, a halogen atom, a methyl group, —CF₃, —OCH₃, a phenyl group or two R₅ bonded with the same carbon atom to form a saturated or an unsaturated hydrocarbon ring of 6 to 15 carbons; i and j independently are an integer of 1 to 20.

8. The liquid crystal alignment agent of claim 1, based on the total amount of the diamine component (b) as 100 moles, an amount of the diamine compound containing carboxyl group (b-1) is 20 moles to 60 moles.

9. The liquid crystal alignment agent of claim 1, based on the total amount of the polymer composition (A) as 100 parts by weight, an amount of the photopolymerizable compound (B) is 5 parts by weight to 30 parts by weight.

10. The liquid crystal alignment agent of claim 1, wherein an imidization percentage of the polymer composition (A) is 30% to 90%.

11. A liquid crystal alignment film formed by a liquid crystal alignment agent of claim 1.

12. A liquid crystal display element comprising a liquid crystal alignment film of claim 11.
